(19) United States
(12) Patent Application Publication
(10) Pub. No.: US 2006/0221081 A1
(43) Pub. Date: Oct. 5, 2006

(54) Reactive animation

(76) Inventors: Irun R. Cohen, Rehovot (IL); Sol Efroni, Rockville, MD (US); David Harel, Beit Zaylt (IL)

Correspondence Address: Martin Moynihan;Anthony Castorina, Suite 207, 2001 Jefferson Davis Highway, Arlington, VA, 22202, US

(21) Appl. No.: 10/542,591

(22) PCT Filed: Jan. 15, 2004
(86) PCT No.: PCT/IL04/00044

§ 371 Date: Mar. 14, 2006

Related U.S. Application Data
(60) Provisional application No. 60/440,640, filed on Jan. 17, 2003.

(51) Int. Cl. G06T 15/70

(52) U.S. Cl. 345/473

(57) ABSTRACT

System and method for generating reactive animation, providing a generic link between tools for graphic animation, by operatively linking the representation of an event driven system in conjunction with an event driven engine to an animation engine to generate reactive animation.

### FIELD OF THE INVENTION

The present invention relates to a system and method for reactive animation, and in particular to such a system and method in which events are generated and evaluated by an event driven engine for the execution of reactive graphic animation by an animation engine.

### BACKGROUND OF THE INVENTION

Animation of complex behaviors is very difficult to create, for example for animation of a complex situation, and/or for adding complex behavior to animation. Currently, a large amount of animation is predetermined, in that the exact behavior of the animation must be known and created in advance. Other types of animation, which are less predetermined in nature, are difficult to create and/or are created by using inefficient, often manual, processes.

One example of a situation which features complex behaviors involves interpreting sets of data in science. The task of collecting data and displaying it in a readily comprehensible format is complex, particularly for dynamic data. For example, scientific papers, often the sources of such dynamic data, may provide a complex dataset for a given phenomena in text, table, and figures that are difficult to translate into other media. The language used in scientific papers is usually comprehensible only to the specific field of research.

For example a specific scientific topic may be researched in different fields, for example cell migration and cell differentiation, which may include data from histology, electron microscopy, biochemistry, and molecular biology. Each field forms a specific viewpoint and dataset. Therefore, constructing representations of models which are useful for comprehension by scientists in other fields and/or which are useful for phenomena which are not restricted to a particular field, can be quite difficult.

One particularly difficult problem is dynamic modeling of a system, which requires that changes to a system be both modeled and represented. The representation of a dynamic model requires that changes over time be accurately depicted, in a manner which is comprehensible to other scientists.

Theoretically, animation of a model could solve this problem, by allowing dynamic, changing representations of the model to be easily displayed. Unfortunately, animation is currently produced frame by frame, thereby giving the illusion that the objects in the animation perform some interactions among themselves. The objects in this “standard” animation do not sense each other and their behavior is not the outcome of some defined description of stimuli and response. Therefore, this type of representation is not useful for a model, as it is predetermined and does not reflect dynamic changes in the model itself.

Furthermore, animation in general suffers from this limitation, as it limits the possible interactions between objects to those which have been previously determined. For computer games, for example, such a limitation restricts the ability of a player to interact with the game, and also limits the possible of a realistic representation of a virtual world in the game. This limitation also increases the cost of creating animation, as visual depictions must be predetermined and manually programmed in the scripting language of the animation tool, rather than allowing such representations to arise naturally as a result of interactions between the objects. As noted above, such animation is not easily or efficiently constructed without being predetermined, which is a clear drawback of the background art.

### SUMMARY OF THE INVENTION

The background art does not teach or suggest a system or method in which reactive animation may be easily or efficiently performed. The background art also does not teach or suggest an easy to implement and efficient system or method for animation in which objects may freely interact in a controlled virtual environment to generate the animation and which are less prone to error.

The present invention is of a system and method for generating reactive animation involved in providing a generic link between tools for the specification and execution of reactive systems and tools for graphic animation. The present invention can optionally be used in a wide range of applications, including computer games, navigation and traffic systems, physiology models, and interactive scientific animation. Reactive animation helps make the programming of such applications more reliable, expeditious and natural. The present invention seeks to operatively link the representation of an event driven system in conjunction with an event driven engine to an animation engine in order to generate reactive animation. Such a combination has not been taught or suggested by the background art in such a sophisticated, efficient manner, since animation has previously been created according to tedious, inefficient predetermined methods. The present invention provides tools which are easy to use and which represent a significant improvement over tools available in the background art.

One focus of the present invention is that many reactive systems can be better represented using true animation, in which the defining features of the system may be captured in a realistic manner. By enhancing the representation of the system with the power of animation, it is possible to show the system changing locations, sizes, colors and shapes, switching components, rotating and shifting. It is also possible to show the system altering its own structure, and/or that of other systems, by eliminating parts of the system and/or adding new parts. The running animation serves as an explanatory tool to the driving simulation. It tells a visual story that is able to closely approximate a real final system, limited only by the graphical manipulative power of the animation tool itself. In the case of multi-agent simulation, it can tell many stories at once that merge into a comprehensive whole.

The present invention therefore preferably enables a reactive system engine to be connected to an animation tool, for producing true reactive animation. The term “reactive animation” preferably refers to the working combination between the power of reactive modeling languages and tools, such as statecharts in Rhapsody (although optionally other reactive languages and tools may be used), and the power of animation tools like Flash Reactive Animation (although again a different animation tool may optionally be used), as described in greater detail below. The combination provides a vivid representation built on a rigorous, hard core model of the system under description. Furthermore, this representation is achieved without the need to perform difficult and tedious coding in the animation tool's scripting language, and without having to build complex and cumbersome animation capabilities on top of the reactive modeling tool.

According to the present invention, preferably systems are simulated and represented by using two separate, detached environments. The simulation is designed without the need of any animation, and the animated components are designed without the need of any code from the model. The final result preferably provides an attached combination of these two components. The model of the system may optionally be built without necessarily considering its future representation in animation. A model may therefore optionally be a regular reactive model of the system, and when building this model, it is not necessary to try to specify the model according to the way in which it is expected to be animated. The system is therefore preferably not specified for the sake of animation, but rather the specification is preferably animated.

In an optional preferred embodiment of the present invention, the event driven system may be a stateful system and the event driven engine may be a state engine. In an alternative optional preferred embodiment of the present invention, the event driven system may be a sequence of action (scenario based) system and the event driven engine may be a sequence of action (scenario based) engine. In another optional alternative preferred embodiment of the present invention, the event driven system may be a temporal (time based) system and the event driven engine may be a temporal (time based) engine. The above-mentioned embodiments are by way of example only and are not meant to be limiting.

A stateful system, a system in which the past history of the system's objects impact future behavior of those objects and the system as a whole is well known in the art. Animation as a means of graphical representation of predetermined systems is well known in the art.

In the optional preferred embodiment of a stateful system, the behavior of objects within a given system is modeled within a reactive animation environment. Objects in a reactive animation environment are preferably mapped to physical objects, or optionally conceptual objects.

States may preferably be logically mapped to animation primitives, simple actions carried out by objects which may preferably not be broken down into simpler actions, and which therefore preferably represent the simplest or most basic actions or portions of the animation. The animation is then created by translating each such state into a visual depiction of the action. It should be noted that an action may optionally be descriptive of the object.

For example, within the context of computer games, the animation would require modeling of movement on the behalf of characters and places, as well as visually descriptive aspects of the characters and places, and possibly even the background.

States describe the behavior of each piece of animation separately. Therefore, the animation engine does not need to be cognizant of what is happening in the scene, but only how to arrange all of the requested pieces of animation. The animation engine makes the animation look realistic. Computer games had previously focused on the appearance of realistic-looking behavior within the game, but were not concerned with actually modeling realistic behavior.

Preferably, in addition to states representing physical changes such as color changes, states may also preferably be mapped to interactions between objects. For example, if an object representing a fist impacts an object representing a piece of paper, a transitional interactive state of “fist punching paper” which models the animation of a fist punching a piece of paper may be generated which has a very limited life span (e.g. 0.3 seconds) and then dies.

After the transitional interactive state of “fist punching paper” has died, the behavior of the fist and the piece of paper may continue to be modeled by states representing the fist and states representing the piece of paper respectively. States modeling the behavior of the fist are preferably mapped to animation primitives depicting the fist, which are output onto a display device. States modeling the behavior of the piece of paper are preferably mapped to animation primitives depicting the piece of paper which are output onto a display device.

Tools for the execution of reactive systems via state engines are well known in the art. Rhapsody™ from I-Logix, Inc. is an example of a commercially available state engine. Graphical animation tools are also well known in the art. Flash™ from Macromedia is an example of a commercially available animation engine. By way of example only, and without any intention of being limiting, the present invention is demonstrated with Rhapsody™ as the state engine and Flash™ as the animation engine.

According to the above optional but preferred embodiment of the present invention, the model is preferably designed by specifying its classes and their interconnections (e.g., with object model diagrams), and their behavior (e.g., with statecharts). Functions and attributes are added. The model is then preferably run, the results are examined and the model is optionally and preferably modified. The specification and the desired animation are preferably integrated by building a few paths of control to coordinate directions and appearance, and to synchronize the running simulation with components from the animation. The viewer may see the result as a running movie, which spontaneously leads to the notion of a directed sequence of events. However, the movie is in fact preferably generated on the fly by connecting the two facets of the system: a representation of how the system works and a representation of what the system looks like.

With regard to biology, the present invention may optionally be used to provide special, powerful visual models of biological systems. A considerable quantity of biological data is collected and reported in a form that can be called “condition-result” data. The gathering is usually carried out by initializing an experiment that is triggered by a certain set of circumstances (conditions), following which an observation is made and the results recorded. The condition is most often (although not always) a perturbation, such as mutating genes or exposing cells to an altered environment. For example, genetic data often first emerge as phenotypic assessments (anatomical or behavioral outputs) that are compared between a mutant background and a defined “wild-type.” Another example includes observations of the effects of anatomical manipulations (e.g. cell destruction or tissue transplantation) on the behavior of the remaining structures. These types of experiments test specific hypotheses about the nature of the system that is perturbed. Many inferences about how biological systems function have been made from such experimental results, and the consequent understanding based on these logical inferences is becoming increasingly, even profoundly, complex.

One feature of these types of experiments is that they do not necessitate an understanding of the particular molecular mechanisms underlying the events. For example, much information can be ascertained about a gene's function by observing the consequences of loss of that function before the biochemical nature or activity of the gene product is known. Moreover, even when the biochemical activity is known, the functional significance of that activity in the context of a biological system is often deduced at the level of phenotypic output. Naturally, with knowledge of molecular mechanisms, increasingly sophisticated inferences can be made and more detailed hypotheses tested, but the outputs, such as a certain cell fate acquisition, changes in gene expression patterns, etc., are often recorded and analyzed at the level of a phenotypic result. Thus, a large proportion of biological data is reported as stories, or “scenarios,” that document the results of experiments conducted under specific conditions. The challenge of modeling these aspects of biology is to be able to translate such “condition-result” phenomena from the “scenario”-based natural language format into a meaningful and rigorous mathematical language. Such a translation process allows these data to be integrated more comprehensively by the application of high-level computer-assisted analysis. In order for it to be useful, the model must be rigorous and formal, and thus amenable to verification and testing.

The present inventors have found that modeling methodologies originating in computer science and software engineering, and created for the purpose of designing complex reactive systems, are conceptually well suited to model this type of condition-result biological data. Reactive systems are those whose complexity stems not necessarily from complicated computation but from complicated reactivity over time. They are most often highly concurrent and time-intensive, and exhibit hybrid behavior that is predominantly discrete in nature but has continuous aspects as well. The structure of a reactive system consists of many interacting components, in which control of the behavior of the system is highly distributed among the components. Very often the structure itself is dynamic, with its components being repeatedly created and destroyed during the system's life span.

The most widely used frameworks for developing models of such systems feature visual formalisms, which are both graphically intuitive and mathematically rigorous. These are supported by powerful tools that enable full model executability and analysis, and are linkable to graphical user interfaces (GUIs) of the system, which may optionally be implemented as animation for example, as described in greater detail below. This enables realistic simulation prior to actual implementation. At present, such languages and tools—often based on the object-oriented paradigm—are being strengthened by verification modules, making it possible not only to execute and simulate the system models (test and observe) but also to verify dynamic properties thereof (prove).

According to the present invention, there is provided a method for producing animation of an object comprising: modeling a behavior of the object as a plurality of events; creating a visual depiction at least of the plurality of events; detecting an event associated with the object; and creating the animation according to the event with the visual depiction.

Preferably, the plurality of events comprises a plurality of temporal samples or a plurality of scenarios. Also preferably, the plurality of events comprises a plurality of states. More preferably, the method further comprises determining at least one transition between the plurality of states.

Most preferably, the at least one transition is determined according to at least one rule.

Optionally, the creating the visual depiction further comprises creating a visual depiction of the at least one transition.

Also optionally, the state represents an interaction between a plurality of objects.

Preferably, the method further comprises: interacting between a plurality of objects; and altering a state of at least one object according to the interacting.

Preferably, the method further comprises: receiving an external input; and altering a state of at least one object according to the external input. More preferably, the external input is provided through a user interface. Most preferably, the user interface is for interacting with a computer game.

Optionally and preferably, the detecting the state is performed by a state engine, and wherein the creating the animation is performed by an animation engine, the method further comprising: receiving a command from the state engine; parsing the command to determining the state of the object; and translating the command to a format for the animation engine for creating the animation.

According to another embodiment of the present invention, there is provided a system for producing reactive animation of an object, wherein a behavior of the object is modeled as a plurality of events, comprising: (a) an event driven engine for modeling the plurality of states and at least one transition between the plurality of events; (b) an animation engine for creating a visual depiction at least of each of the plurality of events; and (c) an interface for receiving an event associated with the object from the event driven engine, and for sending a command to the animation engine for creating the visual depiction according to the event.

Preferably, the event driven engine comprises a temporal logic engine or a scenario based engine; and the plurality of events comprises a plurality of time samples or a plurality of scenarios. More preferably, the event driven engine comprises a state engine; and the plurality of events comprises a plurality of states. Most preferably, the system further comprises: a plurality of statecharts; and a state processor.

Optionally, the animation engine comprises: a plurality of animation pieces; a rendering engine; and an input translator.

Also optionally, the state engine comprises Rhapsody™ and the animation engine comprises Flash™.

Optionally and preferably, the system further comprises: (d) an external input module for sending a command to the interface for interacting with the object. More preferably, the external input module comprises a user interface. Most preferably, the user interface operates in response to mouse clicks. Alternatively and most preferably, the user interface is comprised within the animation engine. Also, alternatively and most preferably, the user interface is operatively associated with the animation engine.

Optionally and preferably, the user interface is comprised within the interface.

Also optionally and preferably, the user interface is operatively associated with the interface.

According to another embodiment of the present invention, there is provided a method for analyzing a biological system, the biological system featuring a plurality of biological components, the method comprising: providing data related to a plurality of activities of the plurality of biological components of the biological system; analyzing the data to form at least one specification; constructing a plurality of states and at least one transition for at least a portion of the plurality of biological components according to the at least one specification; and creating a visual depiction of the at least a portion of the plurality of biological components in each of the plurality of states.

Preferably, the method further comprises detecting a state of at least one biological component; and creating animation according to the state with the visual depiction. More preferably, the biological system comprises a thymus.

According to still another embodiment of the present invention, a method for analyzing a biological system, the biological system featuring a plurality of biological components, the method comprising: providing data related to a plurality of activities of the plurality of biological components of the biological system; analyzing the data to form at least one specification; decomposing the at least one specification into a plurality of events for at least a portion of the plurality of biological components according to the at least one specification; and creating reactive animation of the at least a portion of the plurality of biological components, the reactive animation being at least partially determined according to the plurality of events.

Preferably, the method further comprises detecting at least one property of the biological system through analyzing the reactive animation.

According to yet another embodiment of the present invention, there is provided a method for analyzing a population having a large number of interacting components, the method comprising: providing data related to a plurality of activities of the population; analyzing the data to form at least one specification; decomposing the at least one specification into a plurality of events for at least a portion of the plurality of components according to the at least one specification; and creating reactive animation of the at least a portion of the plurality of components, the reactive animation being at least partially determined according to the plurality of events. Preferably, the method further comprises detecting at least one property of the population through analyzing the reactive animation.

According to another embodiment of the present invention, there is provided a system for at least providing an interface to a control system, the control system featuring a large number of dynamically created, changed and destroyed moving objects, comprising: (a) an event driven engine for modeling the objects according to a plurality of events; (b) an animation engine for creating a visual depiction at least of each of the events; wherein the event driven engine detects an event associated with the object in the control system, and wherein the animation engine creates the visual depiction according to the event for being provided to the interface.

### BRIEF DESCRIPTION OF THE DRAWINGS

The invention is herein described, by way of example only, with reference to the accompanying drawings, wherein:

FIG. 1 is a schematic block diagram of a preferred exemplary reactive animation system according to the present invention;

FIG. 2 is a graphical representation of a UML model depicting a preferred reactive animation system according to the preferred embodiment of the present invention;

FIG. 3 is a schematic depiction of layering within a preferred reactive animation system;

FIG. 4 is a schematic block diagram of an exemplary preferred reactive animation method;

FIG. 5 is a schematic block diagram of an exemplary preferred reactive animation method demonstrating the building of a plurality of actor and actor-component movie clips in the animation engine;

FIG. 6 is a schematic block diagram of an exemplary preferred reactive animation method demonstrating the building of a simulation/movie/execution/running model in the event driven engine;

FIGS. 7A-C show part of the actual simulation of a thymus model according to the present invention;

FIGS. 8A-C show exemplary menus according to the present invention;

FIG. 9 shows the anatomy of the thymic lobule as animated by the present invention;

FIG. 10 shows competition between cells according to the present invention—FIG. 10A shows the vicinity of an epithelial cell when competition is intact and FIG. 10B shows the results without competition;

FIG. 11 shows that competition influences the cell apoptosis profile locally—FIG. 1I A shows the apoptosis pattern when competition is intact; FIG. 1I B displays the apoptosis pattern in the absence of competition;

FIG. 12 shows that dissociation rates influence lineage commitment; and

FIG. 13 shows an illustration of C. elegans development, showing Vulval cell fate determination. (A) Schematic representation of cellular interactions that determine vulval fates. Signals (arrows and T-bars) are color-coded based on their source. The anchor cell promotes vulval fates. VPC-VPC interactions inhibit adjacent cells from acquiring a 1° fate (and instead promote a 2° fate). The ventral hypodermis inhibits vulval (1° and 2°) fates. (B) Differential interference contrast (DIC) photomicrograph of the central body region of a live C. elegans L3-stage worm; White bar ˜15 μm.

### DESCRIPTION OF THE PREFERRED EMBODIMENTS

The present invention is of a method for providing animation, by determining the behavior of an object according to a plurality of events with an event driven engine, and the visual depiction of that behavior as a plurality of portions of animation by an animation engine. Preferably, an interface translates the information from the event driven engine concerning the event which acted upon the object, into one or more commands for the animation engine. The animation engine then renders one or more portions of animation for display.

In one preferred embodiment of the present invention a method for producing animation of an object includes: modeling a behavior of the object as a plurality of events, determining at least one transition between the plurality of events, creating a visual depiction which at least represents the plurality of events, detecting an event which acts upon the object, and creating the animation according to the event with the corresponding visual depiction.

In an optional preferred embodiment of the present invention, the event driven system may be a stateful system and the event driven engine may be a state engine. In an alternative optional preferred embodiment of the present invention, the event driven system may be a sequence of action (scenario based) system and the event driven engine may be a sequence of action (scenario based) engine. In another optional alternative preferred embodiment of the present invention, the event driven system may be a temporal (time based) system and the event driven engine may be a temporal (time based) engine. The above-mentioned embodiments are by way of example only and are not meant to be limiting. In the optional preferred embodiment of the present invention, the event driven system may be a stateful system and the event driven engine may be a state engine. Within the optional preferred embodiment of the present invention in which the event driven engine is a state engine, at least one transition may preferably be determined according to at least one rule.

Furthermore within the method described above, the visual depiction may preferably be created to further a visual depiction of at least one transition.

Within a preferred embodiment of the present invention, events cause the event driven engine to potentially react. At the very least, the event driven engine will evaluate whether the event driven engine must take action. Though, any given event may not cause a change of status for an object, the event driven engine must at least evaluate whether or not the status of the event should be changed in response to that event. For example in a stateful system, the state of an object may not change in response to each stimulus.

Events, both external and internal events, represent stimuli to the engine.

Internal events occur when there has been a change within the event driven engine. Some other factor affected a change within the event driven engine for whatever reason and that change generates an event.

External events occur when external stimuli act upon the event driven engine within the reactive animation system. For example, user input entered through a user interface may act as a means of generating external events.

Within an exemplary and optional embodiment of an event driven engine, there may preferably be different sequences of events (scenarios). An event occurs and the event engine evaluates whether a change should occur. If the event does not match to any event which has an effect, the event driven engine may preferably not effect a change. For example, within a scenario based system action follows action and possible scenarios could be, the ball comes to a soccer player, the soccer player hits the ball, and the ball moves somewhere else.

In a stateful system, every state needs to be mapped. For example to represent the behavior of a soccer player in a stateful system all of the states that Soccer player can be in must be represented, for example: the soccer player hitting the ball, the soccer player kicking the ball, the soccer player running with the ball, and the soccer player trying to get the ball.

In another alternative preferred embodiment of the present invention, the event driven engine may be a temporal logic engine and the reactive animation may be modeled by a temporal system, a system in which the status of objects within a system are sampled at discrete moments in time.

In a computer game, there may be more than one sequence, but the sequences are set. However in alternate preferred embodiments of the present invention, there may preferably be multiple sequences or multiple scenarios, multiple states, or multiple objects being sampled with respect to time.

In an exemplary, but preferred embodiment of the present invention a system for producing animation of an object is modeled, in which a behavior of the object is modeled as a plurality of states, including: a state engine for modeling the plurality of states and at least one transition between the plurality of states, an animation engine for creating a visual representation at least of each of the plurality of states, and an interface for receiving a state of the object from the state engine, and for sending a command to the animation engine for creating the visual depiction according to the state. Within a given stateful system, each state may be entered from multiple other states. For example an “end of game” state may preferably be entered at the end of all possible paths within a given reactive animation system.

In order to assist in diagramming the states and determining the state of an object, Statecharts may optionally be used. Statecharts is a visual language, invented by D. Harel in 1984 [17, 18] to assist in the development of the avionics system of a new aircraft. Statecharts has since become the subject of research for many groups [19, 20, 21, 22] as the main formalism used to specify the behavior of complex reactive systems in a variety of industries, and has been adopted as the central medium for describing behavior in the Unified Modeling Language (UML), a world standard for object-oriented specification and design of systems [23].

Behavior in Statecharts is described using states and events that cause transitions between states. States may contain sub-states thus enabling description at multiple levels, and zooming in and zooming out between levels. States may also be divided into orthogonal states, thus modeling concurrency, allowing the system to reside simultaneously in several different states. Statecharts are rigorous and mathematically well defined and are therefore amenable to execution by computers. Several tools have been built to support Statecharts-based modeling and execution, and to enable automatic translation from Statecharts to machine code.

Within the system described above, the state engine preferably comprises Rhapsody™ [24] and the animation engine preferably comprises Flash™ as non-limiting examples thereof.

Preferably within the system described above, there is an external input module for sending a command to the interface for interacting with the object.

Additionally within the system described above, the external input module comprises a user interface.

The principles and operation of the present invention may be better understood with reference to the drawings and the accompanying description.

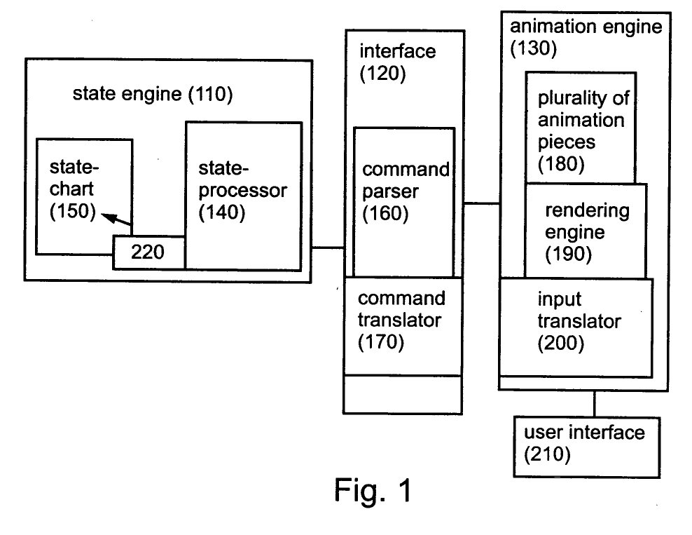

Referring now to the drawings, FIG. 1 is a schematic block diagram of a preferred exemplary reactive animation system according to the present invention.

Reactive animation system 100 comprises a state engine 110, an interface 120, and an animation engine 130. The state engine 110 further comprises a state processor 140 and at least one statechart 150 (preferably written in the language, Statecharts). Preferably each object has an associated statechart 150, such that there is a plurality of statecharts 150.

The interface 120 further comprises a command parser 160 and a command translator 170. The animation engine 130 further comprises a plurality of animation pieces 180, a rendering engine 190, and an input translator 200. A user interface 120, whereby a user (not shown) may preferably interact with the reactive animation system 100 may be operatively linked to the animation engine 130 or comprised within the animation engine 130.

In alternate embodiments the user interface 210 may be comprised within the interface 120 or operatively associated with the interface 210.

In a preferred embodiment the user interface 210 is preferably implemented as a graphical user interface (GUI). When the user clicks on part of the screen, (for example when working in conjunction with an operating system such as the Windows™ (Microsoft Corp USA) operating system, which can interpret mouse clicks), the animation engine 130 may preferably recognize that an event occurred where a mouse click occurred at these coordinates.

Optionally and preferably the animation engine 130 is implemented as a Flash animation engine, or a similar type of engine with similar capabilities that are known in the art. The Flash engine already has the built in capability to interpret user inputs under certain basic circumstances. Flash understands what these inputs mean with respect to the animation. Flash may then send a command back to the interface 120, informing the interface 120 that a click occurred and sending a query for further instructions.

In an alternative embodiment, the input translator 200 is operatively associated or comprised within the interface 120, in which case, the interface 120 has to determine two types of information. First, the user interface 210 needs to be aware of events caused or driven by the user. For example for a mouse click, the screen coordinates form part of the data for the event. The user interface 210 also has to be aware of the actions of the animation itself, in order to determine the meaning of the coordinates of the mouse click.

Hence it is preferable for the user interface 210 to be comprised within or operatively associated with animation engines that already have at least a limited ability to interpret events from the user interface 210.

Animation engine 130 preferably has scripting capabilities, such that commands may be passed to animation engine 130 in some type of scripting language. These capabilities are well known in the art, and are provided by many different commercially available animation software programs. Animation engine 130 should preferably be vector based, which is also well known in the art. Vector based animation engines describe objects being displayed on a computer monitor or other type of display as a vector, rather than as a bitmap (which is an actual image). Vector based animation can be described in terms of changes to the display, rather than describing each part of the animation as it changes on the display. Such animation is much simpler to program.

Within the state engine 110, the state processor 140 handles states and state transitions, and is able to cause a transition upon receiving input data. By “causing a transition” it is meant that the state of an object is changed from a first state to a second state. In order to assist in the determination of such transitions, state processor 140 preferably comprises software that performs the primary and highly repetitive function of mapping input data (not shown) to various states and commands and inputting the relationships between input data and states into the statechart 150.

Each of a plurality of objects 220 is preferably mapped to one of a plurality of statecharts 150. Each of the plurality of objects 220 represents a plurality of states of an object within an animated environment. For example a subset of the plurality of states for the hand object in a video game reactive animation dataset might comprise a state for a hand at rest, a state for a hand waving, a state for a hand forming a fist, a state for a fist at rest, a state for a fist swinging forward, a state for a fist recoiling backwards, a state for a hand holding a small object, a state for a hand holding a medium object, and a state for a hand holding a large object.

The state engine 110 may preferably not be cognizant of the fact that the state engine 110 is modeling animation information. The state engine 110 is used by the user (not shown) to logically represent the relationships between the plurality of objects 220, and the set of commands (not shown) input by the user that governs the means by which the plurality of objects 220 interact within the animation environment.

The interface 120 is the part of the system that enables the state engine 110 and the animation engine 130 to communicate. Within the interface 120, the command parser 160 interprets the commands generated by the state engine 110 via the construction of commands by the state processor 140 by reading the statechart(s) 150.

The command translator 170 interprets the parsed output of command parser 160 from a form that is intelligible to the state engine 110 into a form that is intelligible to the animation engine 130, preferably producing a plurality of animation pieces 180 and a set of animation instructions (not shown) which the rendering engine 190 utilizes to produce a reactive animation model on a display device (not shown). By way of example and without being limiting, the display device may comprise any display device as is well known in the art including a television screen and a computer screen.

In some preferred embodiments of the present invention, the user (not shown) may not interact with the reactive animation model. In other preferred embodiments of the present invention, the user may interact with the reactive animation model via an optional user interface 210.

In one preferred embodiment of the present invention, user inputs entered via the user interface 210 are translated by the input translator 200 and may preferably directly change the way objects are displayed on the display device by changing the appropriate parts of the plurality of the animations pieces 180. The input translator 200 preferably communicates with animation engine 130, for reasons described in greater detail above, which then sends commands and/or information to command parser 160 about the change(s) that have occurred.

The command translator 170 then interprets these changes into data that can be understood by the state engine 110. The state processor 140 then makes the appropriate change(s) in the current situation of the appropriate statechart(s) 150.

In another alternative preferred embodiment, the user interface 210 may communicate directly with the interface 120 via the input translator 200 (positioned in the interface 120 instead of the animation engine 130). The input translator 200 would then route translated user input data to the command translator 170 in the interface 120. The command translator 120 would then translate and route the data representing the user initiated changes to both the state engine 110 and the animation engine 130 in a form which both the state engine 110 and the animation engine 130 could respectively utilize. Both the state engine 110 and the animation engine 130 would alter the data as requested by the user via conventional internal means as is well known in the art. Optionally, user interface 210 may be operatively associated with state engine 110.

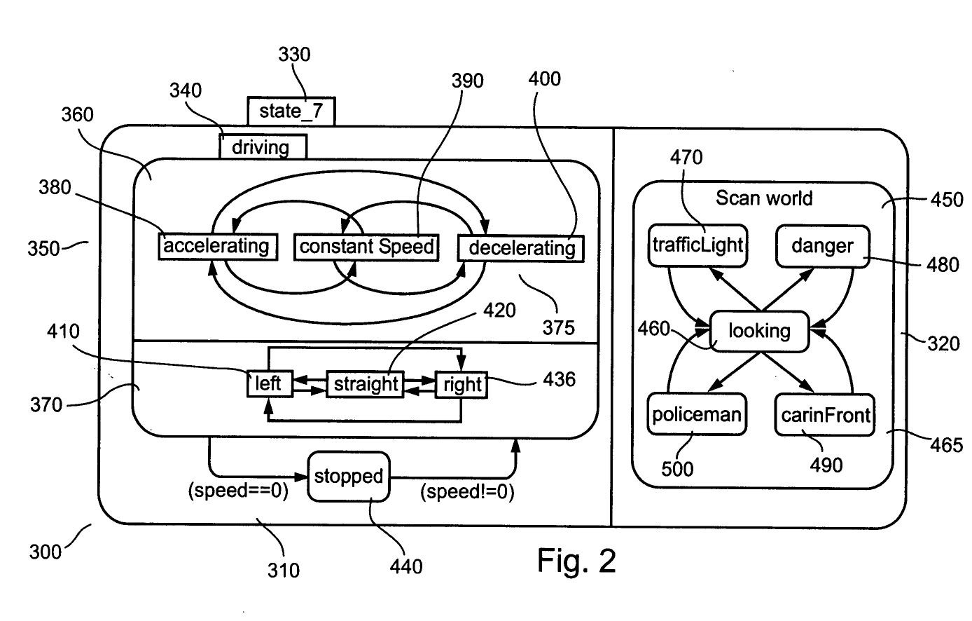

FIG. 2 is a graphical representation of a portion of a UML model depicting a preferred reactive animation system according to the preferred embodiment of the present invention.

By way of example only, without any intention of being limiting, FIG. 2 illustrates a portion of a Unified Modeling Language (UML) model 300 of a reactive simulation of a car interacting with road traffic. The Unified Modeling Language (UML) model 300 comprises at least one statechart 310 and an object model diagram 320.

The statechart 310 represents a stage tag 330 which demonstrates that the car interacting with road traffic is in state_7. The state mode 340 demonstrates that the car is driving. Within the state mode 340 there is a plurality of state descriptors 350 which further describe the state mode 340.

In the example of a car interacting with road traffic in state tag 330 state_7, the plurality of state descriptors 350 comprise an acceleration module 360 and a direction module 370. The acceleration module further comprises a plurality of acceleration module alternatives 375 comprising accelerating 380, constantspeed 390, and decelerating 400. It should be noted that this diagram shows only a few features of the state system for clarity only, as additional states may be desirable for this system. Furthermore, this diagram does not include other classes that may interact with the automobile according to their own states, and as such does not completely represent a traffic model.

Acceleration module 360 demonstrates that when the car is driving, the car can either be accelerating, decelerating, or driving at a constant speed. The arrows which point between the alternatives accelerating 380, constantspeed 390, and decelerating 400 demonstrate that from any one of the three alternatives mentioned above, the car can change to any of the other two alternatives.

The direction module 370 demonstrates that the car's direction can be left 410, straight 420, or right 430.

Whenever the scalar quantity of speed is equal to zero within the state mode 340 of driving the car leaves the driving mode 340 of driving and enters the stopped submode 440. When the car is in the stopped submode 440 and the scalar quantity of speed becomes nonzero the car re-enters the state mode 340 of driving.

The system of the car (not shown) comprises a driver (not shown) who interacts with outside stimuli in the traffic simulation. The object model diagram 320 demonstrates the driver's interaction with outside stimuli. The object model diagram 320 comprises a scan module 450 which models the driver's behavior via the looking module 460. Via the looking module 460 the driver scans the surroundings for factors of interest comprising a plurality of factors 465 preferably represented by a trafficLight 470, a danger flag 480, a carinFront flag 490 representing a car in front of the driver's car, and a policeman 500. Data in the statechart(s) 150 (of FIG. 1) may preferably be changed in the state engine 110 (of FIG. 1) by the state processor 140 (of FIG. 1) based upon the factor encountered by the driver as encountered by the looking module 460.

After one of the plurality of factors 465 is encountered, and any necessary stage changes are made to the statechart 150, logical control of the object model diagram 340 continues with the looking module 460.

Another part of the model is the infrastructure that enables traffic motion. This infrastructure is a representation of streets and sidewalks to facilitate movement and positioning of all other objects. This infrastructure may be modeled as a two dimensional lattice that holds the positions, sizes and visual features of the reactive objects (cars, people, etc) and stationary objects (roads, buildings, etc).

The model was tested for traffic according to the present invention. Exemplary results of the model testing are shown at www.wisdom.weizmann.ac.il/˜dharel/TEMP/cars.exe. The model fulfilled all expectations for the present invention.

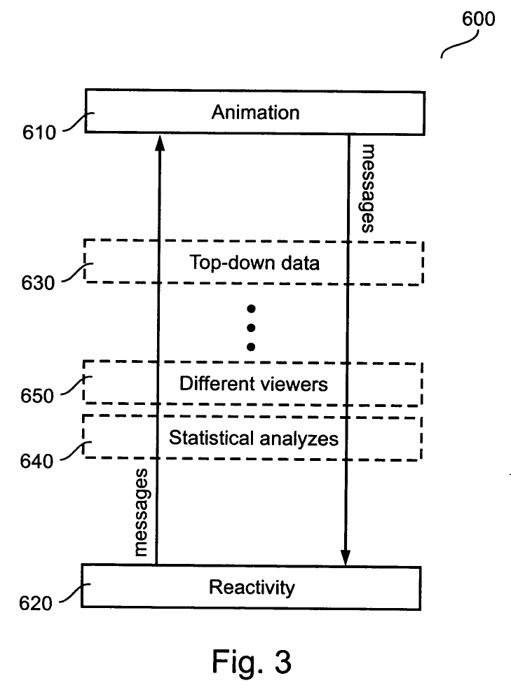

FIG. 3 shows a schematic depiction of logical steps to construct a preferred reactive animation model.

Logical flow 600 demonstrates layering in reactive animation. The Animation Layer 610 communicates with the Reactivity layer 620 via a series of bidirectional messages. The interface 120 (FIG. 1) generates several intermediate layers that enable communication between the Animation layer 610 and the Reactivity layer 620 including, but not limited to, top down data 630 and statistical analyses 640. The interface 120 also preferably comprises customization data for different viewers 650 which enables a given reactive animation system to be displayed on a plurality of different display devices (not shown).

These different layers support statistical analyses of the behavior of different objects and/or sets of objects in the modeled system. For example, each user could decide to focus on different aspects of the modeled system. Also, the different layers enable different parts of the present invention to be operated by different computers and/or CPUs, further increasing the speed and efficiency of the operation of the present invention.

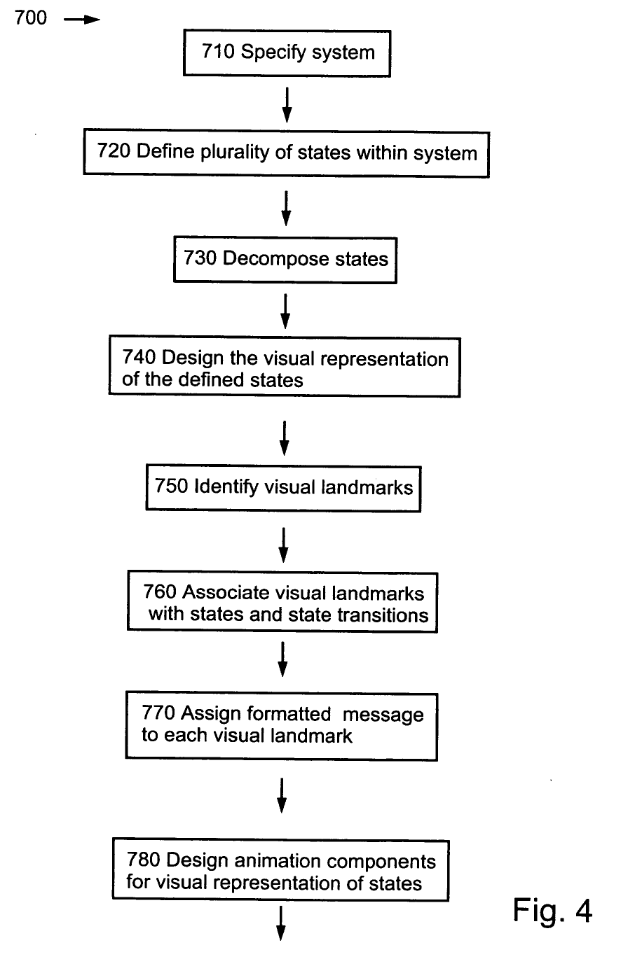

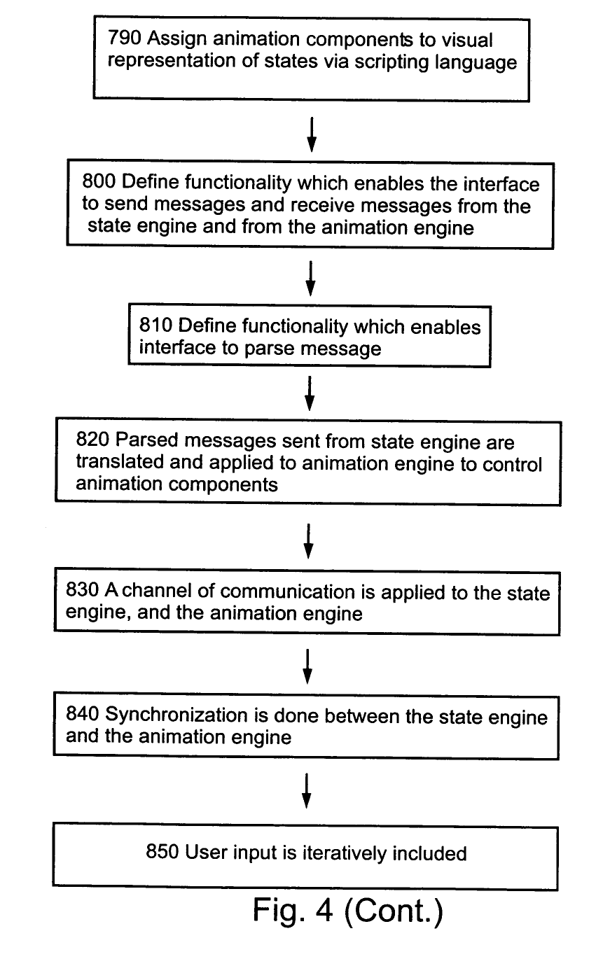

FIG. 4 is a schematic block diagram of an exemplary preferred reactive animation method 700 for a given system.

In stage 710 a system is specified. For example, and without intention to be limiting, the system may be specified in the form of a UML model (as illustrated in FIG. 2)

The system further comprises stage 720 in which a plurality of events which comprise the system are defined. In stage 720, the plurality of events is represented as a plurality of states. In stage 730, the plurality of states is decomposed into a statechart for each object.

Throughout the system associated with FIG. 4, by way of example only and without any intention of being limiting, the plurality of events is represented as a plurality of states.

In stage 740, a visual representation of the defined event stages is designed. In FIG. 4, by way of example only and without any intention of being limiting, the representation of events is represented as a representation of states.

In an alternative preferred embodiment of the present invention stage 740 and stage 710 may be interchanged in which the plurality of states would be determined from a visual representation.

In stage 750, visual landmarks are identified. Identification of visual landmarks is done on the model of the system. In the model, events (i.e. states), messages and attributes that are important to the visual representation are identified. This stage also involves determining the visual form that an object has in the graphic animation. For example, the visual form may optionally be more abstract or symbolic, or alternatively, more detailed and more realistic.

In the example of FIG. 2, such states could be the car's motion data, different states of a traffic light (colors), different activities of a policeman and different activities of pedestrians. A detailed description of traffic may comprise the opening and closing of a car's door, the motion of a car's steering wheel, the car's light, the lighting of the road, the visibility at different conditions and many additional states and attributes.

In stage 760, visual landmarks are associated with states and/or state transitions.

The visual landmarks marked in stage 750 are linked to different parameters in the model. For example, the car's motion data could be associated with states that represent acceleration data, with attributes that stand for the car's speed, and with the state that indicates the path of motion (left turn, right turn).

In stage 770, formatted messages are preferably determined at least for each state transition. The states and optionally other parameters are now preferably associated with a formal action to execute for one or more state transitions, for example for sending a command to the animation engine. Optionally, the messages are bi-directional, in which the animation engine may also have one or more messages associated with changes to the animation, for example through input from the user interface.

When one of the parameters is experienced in the model, during run-time, such that an event has occurred, a message is preferably sent to the animation engine.

For example, in the traffic model of FIG. 2, a message which indicates that the car will turn left will be chosen when the driver decides to turn left. The message will identify the specific car out of the entire fleet together with an indication to the direction of the turn (in this case “left”). In the model, the car preferably examines the surrounding field of vision, to sample available data on visible information in this field. The driver would then decide to turn left, change lanes or take no action. It should be noted that all of these concepts may optionally and preferably be represented by abstract states, with the ultimate action of the car representing a state transition to a new state.

In stage 780, animation components are designed for visually depicting the states of the system.

The animation engine works with components that are later activated, moved, added and changed according to instructions from the state engine. The design of these components can be made using the animation engine or may be imported from any graphical design tool. The design of these components is best made while keeping in mind their reactivity and possible reactions. When an animated component of a car is designed using the animation engine, an image of a car is made. The animated component of a car may be attached to an animation of a car's move to the left and a car's move to the right. The more detailed description would include the opening and closing of doors, details of the steering wheel's movements, the dashboard, and different lights and so on.

In stage 790, animation components are assigned to the visual representation of the states using scripting language. Animation engines usually include a scripting language which provides a limited language which comprises the option to apply simple behavior to various components. The scripting language does not make it possible to apply complicated behavior to components, but only to control the motion and appearance of animated objects through non-sophisticated commands. In the example of FIG. 2, a car may have, at a specific moment in time, a fixed speed. To create the illusion of a moving car with the animation engine, a script can be encoded which creates the illusion of the rotation of the wheels. The script may receive data about the car's velocity and manipulate the images that display the car's wheels. This way, the effect of a rotating wheel is demonstrated but the location and angle of the car's wheels do not need to be continuously updated.

In stage 800, functionality is defined which enables the interface to send messages and receive messages from the state engine and the animation engine.

The functionality defined by stage 800 is preferably a module that may be written in the animation engine. This module makes use of the connective capability of the animation engine. In the example of FIG. 2, Flash's XML socket, enables XML files to be sent and received through a TCP/IP connection. Other tools preferably comprise other communications options. Every animation tool that comprises connectivity to other tools may preferably be configured, using a proper addition of modules, to perform stage 800.

In stage 810, functionality is defined which enables the interface to parse messages. Received messages must be parsed to make sense of the information they convey. For example, an XML message of the form <CAR INDEX=“10” SPEED=“90” TURN=“L”> should be parsed and interpreted as “The 10th car, going 90, is turning left”. The parsing is a convention we, as designers, agree upon as a common language between tools. The message received during animation-time at the Animation engine will be dynamically built according to the dynamics of the running model.

In stage 820, parsed messages sent from the state engine are translated and applied to the animation to control animation components. Parsed messages ultimately control the components of the animation. Whenever a relevant component or animation clip should be added, changed or removed, a proper function is able to bring this behavior into animated realism. Functions are specifically designed to perform different animations. These functions are invoked by parsed messages sent by the reactive modeling tool.

In stage 830, a channel of communication is applied to the state engine, animation engine and interface. There are various alternatives for building a channel of communication between the state engine and the animation engine. According to the particular choice of communication interface (TCP/IP, windows API, etc . . . ), the channel of communication can be optimized. In the example of FIG. 2, TCP/IP is used. With TCP/IP as a choice of communication channel, the hardware may be easily distributed, since most hardware is built to interact through TCP/IP.

In stage 840, a synchronization of data between the state engine and the animation engine is performed. The beginning of a running simulation may preferably be initialized according to a predefined state setup. For example, the simulation may have initially been populated with a populated fleet of traffic, located in a set of roads. Alternatively the state set up may be populated as the simulation runs. Different cars may be assigned different speeds according to some predefined distribution, or depending upon road conditions. The data structure, optionally as well as other factors define how the state engine and animation engine coordinate with each other for synchronization. Examples of these other factors include but are not limited to, error handling and simulation parameters.

In stage 850, user input is interactively taken into account in determining state data and animation data.

According to another optional but preferred embodiment of the present invention, there is provided another implementation of the system and method above with a different visual, animation engine in place of Flash™ from Macromedia. This implementation preferably uses Director™ from Macromedia to allow a GUI (graphical user interface) to be constructed for the reactive engine (constructed from a reactive modeling language), and hence for animation to be more easily provided.

According to an optional but preferred embodiment of the present invention, the reactive engine is constructed as a Play-Engine, described in several references (D. Harel and R. Marelly, Come, Let's Play: Scenario-Based Programming Using LSCs and the Play-Engine, Springer-Verlag, 2003; and D. Harel and R. Marelly, “Specifying and Executing Behavioral Requirements: The Play In/Play-Out Approach”, Software and System Modeling (SoSyM) 2 (2003), 82-107; both of which are hereby incorporated by reference as if fully set forth herein).

With regard to the optional but preferred GUI and the animation to be created from such a reactive engine, as previously described, this implementation preferably uses Director™ from Macromedia. This tool fulfills the requirements of an interface for interacting with the reactive engine constructed according to the Play-Engine. These features include: a COM interface implementation that is able to show and hide the GUI window, change and retrieve the property values for GUI elements, highlight GUI elements, find their location and size on the computer screen and call internal GUI functions; the ability to callback the Play-Engine application through its COM interface to inform when a GUI element was changed, left-clicked or right-clicked with a mouse or other pointing device; a XML description file including the full list of GUI elements to be controlled by the Play-Engine, their names, property type, and so forth. The new GUI editor should be able to create all the above almost automatically, with minimum iterations with the GUI designer and Play-Engine user.

Like Flash™, the reader (user software) for Director™ is freely available, which is clearly an advantage. Director™ also has a number of advantages over Flash™, although the present invention may optionally be implemented with either animation tool. Flash™ does not support full three-dimensional animation, although there are ways to create scenes that appear to be three-dimensional, which can fool most users. Flash™ also does not support any extension mechanism in the form of plug-ins, but instead supports a limited scripting language.

Macromedia Director™ supports most, if not all, of the items previously described as being important, including the ability to create true three-dimensional animation and also playing embedded Flash™ animations. It has a limited scripting language that allows the creation of custom widgets and behaviors outside the scope of Play-Engine control. Director™ also features an extension mechanism called Xtras, a DLL based plug-in system that can be used both in the editor environment and into final product animations. Through this Xtras feature, the communication channel with the Play-Engine application is preferably implemented.

Macromedia Director™ allows the use of plug-ins called Xtras to create new features both for the editor and for the final multimedia application, called a Shockwave movie. These Xtras are DLLs (dynamic linked libraries) that implement a specific number of COM like interfaces defined by Macromedia Director™. These Xtras can be implemented under any programming language that supports COM interfaces, such as C/C++. For this implementation C++ is optionally and preferably used under Microsoft Visual Studio.

Another feature present in Director™ is a limited scripting language called Lingo that can be used to create custom behaviors for Shockwave components. This scripting language is preferably used by the current implementation as described below.

The present invention may therefore optionally use an Xtra plug-in for implementing the interfaces defined by both Macromedia Director™ and by the Play-Engine and for enabling a communication channel between a Shockwave movie and the Play-Engine application. The plug-in preferably performs two main activities: first it monitors the Shockwave components to inform the Play-Engine when they are clicked or their values changed; second it receives Play-Engine orders for modifying values, highlighting components or showing the Shockwave window as defined by the GUI COM interface.

The Xtra plug-in software development kit supplied by Macromedia Director does not allow C++ Xtra code to directly register to events occurring inside Shockwave movies, such as mouse clicks. It does allows an Xtra plug-in to modify the Lingo script associated with components, therefore in order to monitor a component, a Lingo script is written for each component, which calls the monitoring Xtra plug-in functions to inform the plug-in about internal activities. A second Xtra plug-in, which is preferably used in the Director™ editor application, preferably automates the process of creating such Lingo scripts. This script creator Xtra plug-in preferably allows the user to select components from the Shockwave movie being created, automatically create monitoring Lingo scripts and export component names, types and references to the XML description file required by the Play-Engine.

Shockwave movies are generally played by a standalone freeware player or by a Shockwave plug-in for web browsers. Another alternative is a standalone application that includes the Shockwave movie, the player code and all the needed Xtras plug-ins inside a single executable file. These kinds of files are called (by Macromedia Director™) a Projector application, and can be created directly from the Director™ editor.

The behavior of many reactive systems, including a complex biological model of T-cell behavior in the thymus, can be modeled with a state engine and animation engine in tandem through an interface which enables the state engine and animation engine to communicate with each other, as described with regard to the illustrative, non-limiting examples below.

### EXAMPLE 1

### Implementation with a Model

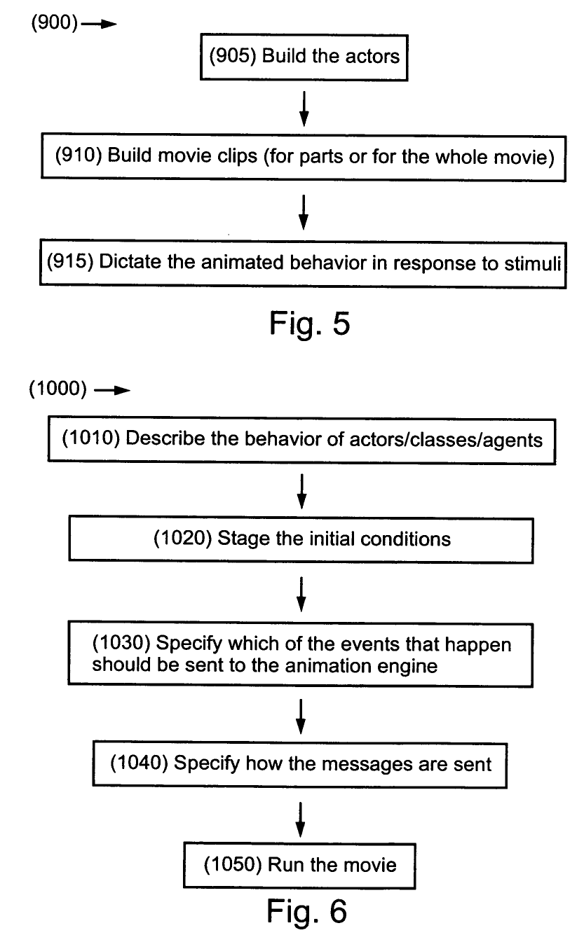

Reference is now made to FIG. 5, which is a schematic block diagram of an exemplary preferred reactive animation method demonstrating the building of a plurality of actor and actor-component movie clips in the animation engine.

Reference is also now made to FIG. 6, which is a schematic block diagram of an exemplary preferred reactive animation method demonstrating the construction of a simulation/movie/execution/running model in the event driven engine.

The block diagrams of FIG. 5 and FIG. 6 demonstrate the use of the present invention to construct a film portion with an example of a man walking his dog. The interaction between the event driven engine (a state engine in the present example), and the animation tool or animation engine, is performed substantially as previously described. More specifically, to behaviorally direct animation from the event driven engine, the user should:

I. Build actor and actor-component movie clips in the animation engine (demonstrated in FIG. 5)

II. Build the simulation/movie/execution/running-model in the event driven engine

(demonstrated in FIG. 6)

The method which generates the actor and actor-component movie clips of FIG. 5 is generally designated 900.

In stage 905, the actors are built. The man, the dog, the street, the leash, other dogs or other people that may be encountered are graphically designed.

In stage 910, movie clips (for parts of the movie or for the whole movie) are built for any kind of behavior the actors may encounter and respond to. For example, a movie clip for the dog wagging its tail; for the leash; for the dog's bending and the man's walking may be built.

In stage 915, the animated behavior in response to stimuli is dictated. For example, the command “wag tail” coming from the event driven engine should have an appropriate mechanism in the animation engine that tells the animation to start playing the tail wagging movie clip.

The response to a stimulus should be able to handle features of the stimulus. For example, the command “wag tail” will usually arrive with more data about its features: for example, the speed of wagging.

Any scene in the movie is therefore the result of sequential attachment, removal, change of size, change of location, change of angle, change of color, etc. of the different movie clips that comprise the whole movie.

One scene on the movie may be a meeting between two dogs. According to the nature of the meeting (presumably the odors the dogs exchange), the features of the dogs' tails change. If they are two males, for example, the wagging of the tails will be of some specific speed, different from the speed induced by a male-female encounter.

FIG. 6 demonstrates how the simulation/movie/execution/running-model is built in the event driven engine.

The method which demonstrates how the simulation/movie/execution/running-model is built is generally designated 1000.

In stage 1010, the behavior of actors/classes/agents are described and designed. This may be done with tools specifically built for the job (e.g. via Rhapsody™) or in any other way that is convenient for the designer.

The example has objects such as the man, his dog, other people and their dogs, the infrastructure (the street they walk upon), trees, cars, etc.

The behavior of these objects would usually include the methods that make them move around, the way they sample their environment (sniff, see, feel, hear).

In stage 1020, the initial conditions are staged. The people and dogs are given a designation of where to be at the start.

In stage 1030, the events which should be sent to the animation engine are specified.

For example, movements of the man and dog will be reported to the animation engine, but stages of information processing are not reported (unless needed).

In stage 1040, the means through which the messages are sent is specified.

According to the choice of information the designer wants to deliver to the animation engine, a format for this information is selected. For example, a convenient format for a message about the dog's location would be a reference to the specific dog object, followed by the new coordinates.

In stage 1050, the movie is run.

For example, a simple scene from the movie might be instantiated by the interaction of the animation engine and the state engine. Suppose the scenario is determined as follows:

“The man is walking his dog using a leash. They meet another dog or detect food.”

This scenario provides the overall storyline, or description of the film clip. All possible eventualities need to be defined in the event driven engine. For example, the man's ability to walk is determined according to his movement along the grid, which is the street. The dog's movement must be similarly constructed.

One example is when the man is using a leash to walk the dog. The physical properties of the leash are combined into the specification: it can't be longer than a predetermined length, it is connected to the man's hand until decided otherwise and it is connected on the other side to the dog. Yet the visual description of the movement is entirely animation engine based. The arch formed when one end of the leash is 1 meter high and the other is 0.5 meters high (the hand of the man and the height of the dog, accordingly) is entirely the work of the animation engine and should include the way arches look in the presence of gravity, etc. The way the arch changes when one of its anchors is moving (the man is walking) is also the work of the animation engine. The way the arch stretches to a full length when one of its anchors abruptly stops moving (the dog stops to sniff) is, again, a movie clip implemented in stage (2) of part I.

As another example, consider the 3 dimensional odor space to which the dog may respond. If, for example, an odor source (food) is added somewhere in this space (somewhere in the street), the influence of this source flows in space according to the fluid dynamics of the air in the street. The dynamics are described in the event driven engine. If the dog is capable of responding to scents, at one point or another it might encounter the scent from our odor source (the dog smells the food). If the simulated dog is able to navigate by an odor gradient, the dog moves in the direction of the food. These calculations are performed in the event driven engine.

The animation engine knows nothing of odors, navigation, pulling of the leash or the forces applied by the man on his dog, etc. Yet the animation is capable of showing the dog walking in the direction of the food, because the event driven engine continuously sends messages telling the animation engine the location and direction of the dog. The animation is capable of showing the man's hand stretching when the dog abruptly increases its speed, because the movie clip that shows this stretching of the hand has been prepared and because a message telling the animation to use the clip was sent from the event driven engine, when it detected the need to implement this movie clip. The animation shows two dogs meeting, stopping and passing each other with their tails up, because the clips that include the visual depiction of these interactions have been prepared and can be launched upon demand from the event driven engine.

The event driven engine therefore behaviorally directs the movie, while the animation is the collection of movie clips that are the embodiment of the story.

### EXAMPLE 2

### Modeling a Biological System—Thymus

In this Example, specific analytical data are used to construct an integrated dynamic representation. The integration is preferably performed in two integrated facets: specifying the dataset in a way that makes it amenable to execution on a computer; and representing the objects that are explicitly specified in the first facet, which are cells and molecules. The end result is a moving visual simulation of the biological process—intuitive, visual and interactive. This animation is precisely executed by the statechart's specification and not through manual construction and execution by the user.

The present inventors have found that reactive animation allows experimentation and statistical analyses. Furthermore, reactive animation was found to reveal emergent properties of thymocyte development, including but not limited to: 1) the generation of anatomical and functional subdivisions by molecular gradients alone, 2) effects of molecular knock-outs, 3) the existence of cell competition for interaction space, 4) the importance of cell competition for generating zones of apoptosis and differentiation, 5) chemokine consumption, 6) selection for cell speed, and 7) the role of competition in determining the ratio of CD4 to CD8 T cells. Reactive animation illustrates a new generic approach to modeling the emergent properties of complex systems that enables in silico experimentation as a prelude to designing in vivo experimentation.

To form the first part of the present invention, a detailed description of the relevant objects is prepared. The task of collecting the data and translating it into a well-defined, executable, specification is complex in itself Scientific papers—the sources of the data—provide the dataset in text, tables and figures that are difficult to translate into other media. The language spoken in biological papers is usually comprehensible only to the specific field of research. The goal is to translate this dataset into a generic and usable medium, which is referred to as specification.

The specifications derived from the actual data are used as a set of instructions guiding the simulation. The cellular and molecular agents comprising the system refer, as it were, to these instructions to know how to respond to stimuli. The stimuli may be interactions with other cells, interactions with other molecules or various internal events such as the passage of time.

Stem cells arrive to the thymus from the bone marrow, and the developing T cells go through a series of interactions in different locations inside the thymus. The processes a single cell goes through take about two weeks [4], during which the cell may proliferate into 10⁶ offspring cells [5]. The thymic environment is anatomically divided into lobes and lobules, and the lobules are further divided into the areas of the cortex and the medulla. Since the thymic output of mature T cells is the basis of the immunological repertoire, the physiological function of the thymus is relevant to the study of many diseases, specifically AIDS and autoimmune diseases [6, 7, 8, 9].

Different agents constitute the thymus: epithelial cells form a mesh throughout the organ and interact with developing T cells to activate and regulate many of the processes needed for their maturation [10]. Epithelial cells are separated into different subtypes by molecular markers or by anatomical location [11]. Macrophages perform mainly “housekeeping” tasks to clear the thymus of dead cells [12]. Cytokines are the molecules responsible for signaling between the cells. Chemokines are molecules that signal cell movement along gradients [13, 14]. Short segments of proteins, called peptides, combine with other molecules (Major Histocompatibility Molecules: MHC) to induce different T-cell selection events (e.g. [15, 16]). Thymocytes (T cells in the thymus) express many different surface molecules that serve for interactions with other cells and molecules. Epithelial cells, macrophages, cytokines, chemokines, peptides, thymocytes and cell markers are all further divided into dozens of subgroups, which are not detailed here.

The thymic environment, loaded with these different objects, presents a challenge to many researchers from different fields who have detailed knowledge of some of its parts, but yet wish to comprehend the whole. Consider three scales of analysis: molecules, cells and the whole organ.

The molecules most relevant for researchers of the thymus are chemokines, cytokines and receptors on the cell surface. Specialists in cell migration, for example, study how chemokines cause cell migration. They measure chemokine expression levels in different areas of the thymus, on different cells of the thymic stroma and record the responses of thymocytes during different stages of their development. Biophysicists study the interactions between chemokine receptors and their chemokine ligands at the atomic level. Other researchers study cytokines and their influences on events in thymic development. Cytokines are the main vehicle for signaling between cells and so are important in almost every process. Other molecules allow thymocytes to bind to other cells and to the extra-cellular matrix (ECM).

Other fields of research look at these molecules in a different way. In microscopy, molecules are used as markers to distinguish between different cells under the microscope. Researchers in signal transduction look at the same molecules to see how they influence a cascade of events inside the cell.

The questions asked at the cellular level are which cells respond to which stimuli, how many cells of each type are in each thymic area, and how many cell types are in various areas. What are the events that will drive a cell toward one fate and not another? What stages does a cell go through during development? Where is the cell during different stages of development? What are the paths two cells follow when they interact? Which selection events are the most influential? How does mutation influence cell survival?

Researchers looking at the thymus as one whole often see the organ as a “black box”. Their questions include: what is the number of cells the thymus produces under specific conditions? How many cells enter the thymus every day/hour/minute? What are the effects of removing the thymus (thymectomy)? Why does the thymus diminish in size with age? What are the influences of diseases on the thymus and what is the influence of the thymus on disease? Are there mathematical formulas that can recapture thymic output behavior?

But the thymus is one whole. Disjointed research parcels the same molecules and cells into separate fields, and produces data that must be joined, if we are to ever understand T cell maturation in the whole organ. Currently, there is no way to integrate this broad spectrum of different types of data into one view that would be as coherent as the biological environment that produced them.

The present invention overcomes this disadvantage by using the data generated by reductionist biology and integrating the data into a specification model using statecharts as previously described. The model is then executed. The results of the execution are used to drive an animated visual image of cells and molecules and their interactions. This type of representation is easier for humans to comprehend, and yet does not sacrifice mathematical precision. Moving cells and molecules are interactive with the thoughts of the user, and the format provides the user with tools to choose specific views and mediate particular types of execution.

Moreover, the representation may optionally be designed to express different theories. Immunology, like other complex and incompletely characterized fields, uses theories to integrate both known and unknown information. Theories are proposed scenarios. The model and simulation can accommodate different theories. Whenever an interaction takes place, the user (or the simulation itself) can choose one theory from a collection of available theories and instantiate that particular theory to its completion in the simulation. The instantiated theory then sends conclusions back to the simulation. The user can choose a particular theory either during run-time or during specification. The outcomes of various theories can be compared and contrasted.

### Specifying the Thymus with Statecharts

States and Transitions as Descriptors of Cell Behavior

For specification and modeling, as a non-limiting example, the language of Statecharts may optionally be used, as previously described. It is not intuitively obvious that cells and molecules may be naturally described by states and transitions. In fact, there is no consensus on how one should describe cells. However, immunologists, consciously or otherwise, do use states to describe cells. A cell is usually described by the collection of markers it expresses on its surface [25]. For example, a T cell is called “double negative” when neither of the CD4 and CD8 molecules is expressed. A human T cell is referred to as a memory cell when it expresses a molecule called CD45RO+ [26] and as a suppressor cell when it co-expresses CD25 and CD4 without being activated [27, 28, 29, 30, 31]. Immunologists call these molecules markers, but the present invention refers to them, during specification, as orthogonal states of the cell. One may object to describing cells according to markers that are not chemically accurate descriptions. However, the notation is the basis of most immunological reports and immunological terminology.

In Statecharts, transitions take the system from one state to another. In cell modeling, transitions are the result of biological processes or the result of user intervention. A biological process may be the result of an interaction between two cells, or between a cell and various molecules.

Dealing with a Large Dataset

Statecharts provide a controllable way to handle the enormous dataset of cell behavior by providing the ability to specify separation into orthogonal states and by allowing transitions.

### EXAMPLES

### Example 1

### Modeling Thymocyte Movement

To demonstrate the conversion of data into specification, the way thymocytes move in the thymus is followed as a non-limiting example. Thymocytes receive signals from different cells in different locations. To be certain that signals are received at the right time is actually to be certain that the right thymocyte is in the right place at the right time. The molecules responsible for directing cells along a gradient path are called chemokines. The roles of four chemokines are considered: TECK, SDF, MDC and SLC. Thymocytes search their environment for chemokines and move according to the chemokine gradient. Therefore, (1) the simulating gradient must be correct and (2) the thymocyte must respond only to gradients it can currently interact with.

To determine the right gradient, the scientific literature was surveyed to learn which chemokine is expressed where and at what level. This information is available from different papers, ranging from papers whose subject is one specific chemokine and its expression in the thymus [32], to papers dealing with one specific area in the thymus and the expression of different chemokines in that area (e.g. [33]), to papers reviewing chemokine expression patterns in the thymus as a whole (e.g. [34]). The chemokine dataset was integrated to a four dimensional lattice where each dimension stands for the concentration of one chemokine. Thymocytes first find out which of the gradients they should probe, calculate the relevant gradient and finally move.

To find which of the gradients a thymocyte may now probe, the model preferably includes cell types as cell states. In the model (as in immunology), cells are distinguished according to surface markers. The model considers which gradients are relevant at some specific stage. In other words, given a cell in a state characterized by the expression of certain markers and given a certain gradient, where will the cell move?

The scientific literature provides seven cell markers as relevant for gradient decisions. Five of them may be either “expressed” or “unexpressed”, and two of them have an intermediate level of expression termed “low”. The overall number of relevant states is therefore 2⁵×3²=288. At run time, a cell scans through these 288 states, finds the one it is in, and determines which chemokines it may respond to. During specification, each of these 288 states must be examined, to find an equivalent in scientific papers and to provide the biological meaning. During simulation, a decision tree is used to scan through the collection of possible states. Decisions (leafs of the last row) in the tree correspond to cell states. When the scan reaches a conclusion (a leaf), the simulation generates events that tell the cell to which chemokine gradients it may now respond.

### Example 2

### Modeling Epithelial Cells

Another example of specification is the inclusion of epithelial cells in the model. Epithelial cells in the thymus are stationary, yet their behavior is reactive and changes continuously in response to various stimuli. The literature divides epithelial cells into many types. Since most of the work has been done using microscopy, the cell types are usually separated by their location and their size. To this microscopic division, temporal behavior was added, which is the expression of different chemokines and cytokines in response to different events. For example, medullary epithelial cells have shorter processes (arms) than other epithelial cells and are usually no longer than 30 micrometer in length. Medullary epithelial cells are considered the main elements in a process called negative selection, and have been therefore extensively measured for levels of expression of MHC class I and class II molecules.

Epithelial cells were characterized as having not only a location but also a structure. The structure is the cell processes (arms). As thymocytes and other cells move through the thymus, they interact with the processes of epithelial cells.

Specifying Interaction

When two cells meet during run time, directions are required to determine how their interaction should proceed. Researchers do not always know all the details of the interaction, and so they use different hypotheses to suggest possible outcomes of the interaction. The hypotheses and their suggested outcomes are referred to as “theories” and outline them as objects with a behavior specified with statecharts.

The statecharts of the instance are then executed and, according to different parameters, a conclusion of this interaction is reached. The conclusion may be the death of the T cell, instructions to express one or another marker, instructions to express cytokines, instructions to proliferate, and more. Eventually, the instance reaches the state marked with “T”, which means the instance is terminated and will receive no further references. When another interaction of the same kind takes place, another instance of the same kind will be instantiated. Notice that many instances may co-exist, as the result of many thymocyte-epithelial cell interactions occurring at the same time. According to a particular theory, a single epithelial cell may interact with many different T cells.

Using Statecharts to Communicate Theories

The diagrammatic nature of Statecharts makes them legible to scientists from different disciplines. To describe a theory with statecharts, a description given in text and non-formal diagrams is transformed into a rigorous, diagrammatic language. The resulting description is easy to communicate.

By regarding theory as a separate component, it is possible to choose to plug in or unplug a theory on demand. A collection of available theories is built, and one is chosen. The choice of which theory should be instantiated may be made before the simulation is started. For example, all interactions between thymocytes and cortical epithelial cells may be determined to follow one theory, while all other interactions follow a different theory. A choice of theory may also be made at run time, and the user can choose to switch between theories. The choice may also be made at run time by the simulation itself, when the right conditions develop. Theory, in the simulation, thus becomes interchangeable during the run. The simulation is only committed to the data, not to its interpretation.

The Front-End: An Interactive Animation

While the simulation runs, a front-end to its activities is generated and presented to the user. The front-end is an interactive visual interface that embodies cells and molecules. The user can actually see what the cells and molecules are doing.

The General Setup

The representation is a large collection of Flash™ movie clips that are the embodiment of agents and their states as they appear in the simulation running in Rhapsody. While the simulation is genera ting events and is changing the properties of the interacting agents, the simulation sends information about these changes to generate the Flash movie. The animation is generated on the fly. The animation is neither an end result of the simulation, processed at post-run, nor a preprogrammed movie. It is a living image capturing the look and feel of the physical image of the simulated cells and molecules during run-time.

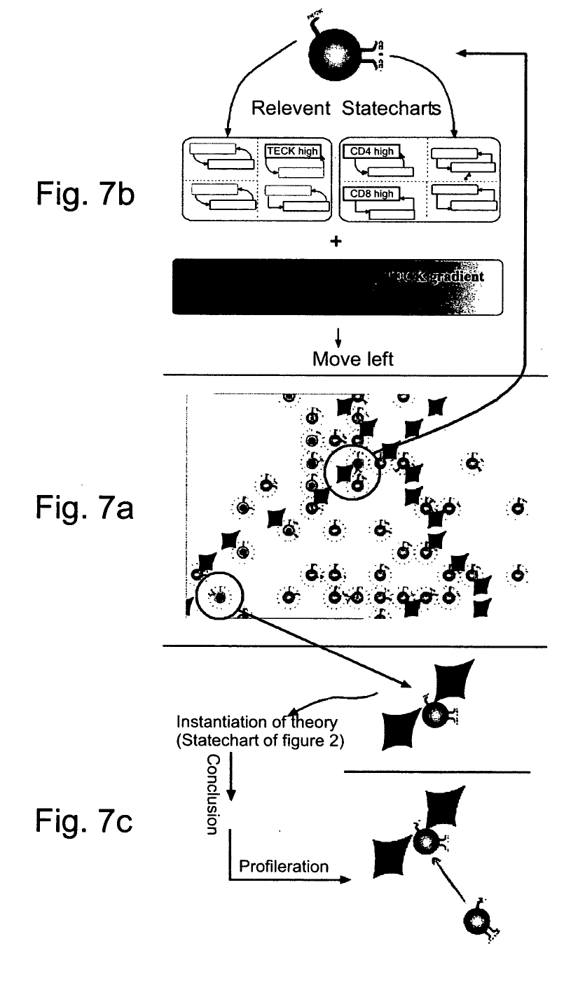

FIG. 7 portrays in part (b) how one thymocyte moves and in part (c) how an interaction with an epithelial cell takes place. Part (a) of the figure gives a snapshot of the running simulation. The figure shows collections of thymocytes around one epithelial cell in the animated user interface. It is important to emphasize that the image of the thymocytes is not a sketch made for the figure but a screen capture of the running simulation.

In parts (b) and (c) of the figure, a sketch of two mechanisms that determine the behavior of the cells is shown. In part (b), below the image of the thymocyte parts of the statechart of the thymocyte are shown. Only two sub-statecharts are shown, corresponding to the three markers visible on the cell's surface and not the full statechart, for the sake of clarity. The thymocyte currently expresses the receptors CD4 and CD8 (the immunological term is DP—Double Positive) and is responsive to the chemokine TECK. Contrary to the two markers for CD4 and CD8, which stand for real surface molecules with that name, the marker for TECK does not signify a molecule, but signifies the ability of the thymocyte to migrate according to a gradient created by that specific chemokine. This notation is used because the experimenters have only limited knowledge of which receptors cause which movements. The available data experimenters provide is of the form “which T cell migrates according to which chemokine” [14, 34, 37, 38, 39, 40]. The sub-statecharts show how receptors are represented as orthogonal states. An expressed receptor will be in the state “high” and an unexpressed receptor will be in the state “low”. On the left statechart, only one state is in “high”. The state represents susceptibility to TECK migration. On the right side, two receptors are in “high”—CD4 and CD8.

To be able to move, the thymocyte represented in the figure (as all other cells) continuously samples its environment. When the thymocyte finds a relevant chemokine gradient—a TECK gradient—it calculates the gradient difference across its surface. Cell movement is directed according to this calculation. In this example, the conclusion is for the thymocyte to move left.

Part (c) of FIG. 7 portrays a different mode of operation. The lower part of FIG. 7 (a) shows a thymocyte next to part of the arm of an epithelial cell, represented as the two adjacent red diamonds. The thymocyte has just migrated from the right and touched the epithelial cell to its left. When the thymocyte and the epithelial cell meet, the conclusion of this specific interaction is the result of several checks made during the execution of the statechart, which checks the states the thymocyte, the attributes of the thymocyte and the properties of the epithelial cell, and finally comes up with the conclusion that, in this case, the specific thymocyte should now proliferate. Proliferation will result in the creation of other thymocytes bearing the same markers and having the same attributes as the parent cell. The proliferation updates the Flash movie. When a new thymocyte is created in the movie, an arrow to designate its ancestor appears and then vanishes.

The simulation handles many such events during run-time. Thymocytes continually move around in the simulated thymus, continuously check their environment for stimuli, respond to the stimuli, proliferate, mature, die, change their receptors, secrete cytokines and interact with other cells. All this is displayed at run-time on the user interface and in animated statecharts generated by Rhapsody. Since every agent in the simulation is in effect an instance in Rhapsody, the user may choose to focus on an animated statechart of the agent. Animated statecharts are useful when events and switches in states during simulation are to be studied.

One may, for example, wish to follow the details of the interaction that resulted in migration towards the medulla. Since Rhapsody provides a “step-by-step” mode, it is possible to interrupt the flow of the simulation at any time and continue one step at a time, while paying attention to relevant attributes and following any switches in states the cells go through. Choices made by “theory” instances are followed, resulting in decisions. This course of action may be referred to as “debugging” the simulated biological process. This occurs at two levels. First, one may watch the visual embodiment of the simulation as it develops in the animated representation, to look for emerging patterns, for dead-end paths, for undefined observables and for mistakes. To carefully scrutinize parts and time bites, the power of animated statecharts is used to progress step-wise. This allows every agent to be examined as one reactive system and to handle the flood of incoming/outgoing events in a controllable way.

### Interactivity

Both the visual user interface and the underlying executed animated statecharts allow the user to manipulate the simulation and to retrieve data. This is done in two separate ways.

Interactions Via User Interface

As described above, the front-end of the simulation is composed of a collection of movie clips. Each of the movie clips is in fact an interactive menu that allows the user to send data to the running simulation. Since the sent data is in fact an XML object (see “Materials and Methods”), it is not limited in its contents. Available operations are perceived as belonging to one of two kinds: data manipulation or data request.

Data Manipulation

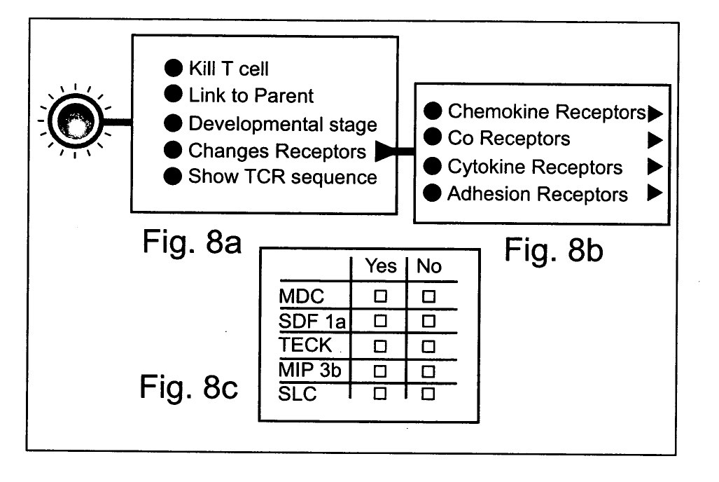

Every object in the animation is also a clickable menu. FIG. 8 demonstrates data manipulation and data request upon clicking the animated thymocyte. The menu item “kill T cell” serves as an example of data manipulation. When the user clicks this item, the underlying executing simulation receives notification that it should now tell this specific T cell to perform apoptosis (programmed death). The results of apoptosis are performed in the simulation itself When the results are processed, the animation will receive the instruction from the simulation to now delete the thymocyte from current view (and to perform any other representation tasks needed).

The submenu “Change Receptors” opens into four submenus that control the cell's receptors (b). Part (c) of the figure shows the submenu that opens the menu item “Chemokine Receptors”. By clicking any element in the checkbox table, the user can change the ability of the cell to migrate to any of the receptors. For example, upon clicking the checkbox in MDC/Yes, the animation sends an event to the simulation. The simulation will then do two things: it will direct the cell that it may now migrate according to MDC and it informs the animation that the thymocyte should now indicate that it is susceptible to MDC (by showing the MDC indicator). The user thus manipulates the simulation exactly in the way data manipulate the simulation. Data manipulation events originating from the user are no different, as far as the simulation is concerned, from events that stem from data specification.

Data Retrieval

In contrast to data manipulation, data retrieval events do not direct or drive the simulation process. The menu items “Link to Parent”, “Developmental Stage” and “Show TCR sequence” of part (a) in FIG. 8 are examples of retrieval events. As seen on movie M3 (supporting online material), when the user clicks the menu item “Link to Parent” the animation retrieves a list of the cell's ancestors. With this list, the animation draws arrows indicating the path of the ancestors. The path will start with the selected thymocyte, draw an arrow to the thymocyte that gave it birth and iteratively follow the line of cells up to the primary thymocyte that started the lineage.

Results of Experiments

Some “in silico” experiments and their results are now described. As noted in the introduction, seven different types of experiments were performed by using the system and method according to the present invention. The results of these experiments, and the correlation with “wet bench” or in vitro experiments for which results are known in the art, are now described.

As previously described, parameters were selected for operating the software which were obtained from published papers and other sources of knowledge in the field. These parameters represent the physiological behavior and elements of the thymus according to available knowledge in the art. In case of a conflict between different publications for these parameters, the most current understanding in the field was selected for determining the parameter. In some cases, preference was given to parameters based on actual, reported experimental results. For exemplary “movies”, showing the experiment as it was performed and the results, see for example www.wisdom.weizmann.ac.il/˜sol/art/.

Reactive animation was used to perform generation of anatomical and functional subdivisions. Reactive animation needs only basic molecular gradients and thymocyte differentiation data to generate an anatomically accurate thymic lobule starting from a few stem cells. Note the preponderance of immature (late double-negative and early double-positive) thymocytes proliferating in the subcapsular zone and the mature (single-positive) T cells in the medulla. Reactive animation shows that the T-cell repertoire largely is selected by thymocytes that proliferate in the subcapsular zone.

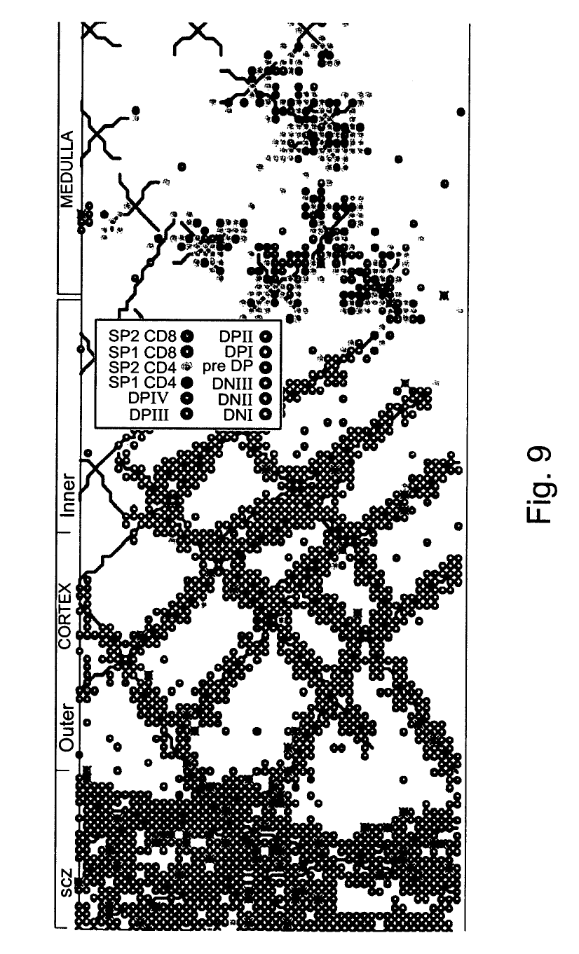

FIG. 9 shows these results, as it demonstrates the anatomy of the thymic lobule. The circles represent developing thymocytes. The figure is a snapshot from the running, animated simulation. Thymocytes are color-coded. Notice the massive proliferation of cells at the sub-capsular zone (SCZ); this means that the T-cell repertoire is largely determined by peptides presented in the SCZ. DN1: CD4⁻CD8⁻ CD25⁻CD44⁺, Lselectin⁻, CD69⁻, no TCRα, no TCRβ; DN2: CD4⁻ CD8⁻CD25⁺CD44⁺, L selectin⁻, CD69⁻, no TCRα, no TCRβ; DN3: CD4⁻ CD8⁻CD25⁺CD44⁻, L selectin⁻, CD69⁻, no TCRα, start rearrange TCRβ; preDP: CD4⁻ CD8⁻CD25⁻CD44⁻, L selectin⁻, CD69⁻, no TCRα, end rearrange TCRβ; DPI: CD4⁺CD8⁺CD25⁻CD44⁻, L selectin⁻, CD69⁻, no TCRα, TCRβ^{low} DP2: CD4⁺CD8⁺CD25⁻CD44⁻, L selectin⁻, CD69⁺, no TCRα, TCRβ^{low} DP3: CD4⁺CD8⁺CD25⁻CD44⁻, L selectin⁻, CD69⁺, no TCRα^{low}, TCRβ^{low} DP4: CD4⁺CD8⁺CD25⁻CD44⁻, L selectin⁻, CD69⁺, no TCRα^{high}, TCRβ^{high} SP1: CD4⁺ or CD8⁺, CD25⁻CD44⁻, L selectin⁻, CD69⁺, no TCRα^{high}, TCRβ^{high} SP2: CD4⁺ or CD8⁺, CD25⁻CD44⁻, L selectin⁺, CD69⁻, no TCRα^{high}, TCRβ^{high}.

Reactive animation was also used to examine the effects of knocking out molecular gradients. The interactive format of reactive animation makes it possible to knock out (KO) molecules or cells and see the effects. Table 1 shows the consequences of three chemokine KOs; two were experimentally confirmed.

The successful correspondence between in silico and in vivo highlights the utility of reactive animation; neither of the resulting KO phenotypes is intuitively obvious.

TABLE 1
Predicted and observed outcomes of chemokine knock outs.

| Chemo- | Thymus Morphology | |
|---|---|---|
| kine KO | Predicted | observed |
| CXCL12 | Accumulation, in low | “Deletion . . . results in |
| | numbers, of DN* cells | failed cortical localization |
| | near the CMJ, highly | and developmental arrest” |
| | reduced numbers in | (Plotkin, J., Prockop, S. E., Lepique, |
| | development | A. & Petrie, H. T. Critical role for |
| | | CXCR4 signaling in progenitor |
| | | localization and T cell differentiation |
| | | in the postnatal thymus. J |
| | | Immunol 171, 4521-7 (2003)) |
| CCL25 | Non-significant | “ . . . deletion had no major |
| | reduction in thymic | effect on intrathymic T-cell |
| | output. May have | development” |
| | significant influence | (Wurbel, M. A. et al. Mice lacking |
| | over ability to | the CCR9 CC-chemokine receptor |
| | choose for faster | show a mild impairment of early T- |
| | cell. | and B-cell development and a |
| | | reduction in T-cell receptor |
| | | gammadelta(+) gut intraepithelial |
| | | lymphocytes. Blood 98, 2626-32 |
| | | (2001)) |
| CCL22 | Developmental arrest | No observation yet |
| | at late DP stages; | |
| | reduced cellularity | |
| | at the medulla. | |

DN, double negative; CMJ, cortico-medullary junction; DP, double positive.

The present invention was also used to examine emergence of cell competition for interaction space. Cell competition was not incorporated explicitly into the Statecharts simulation because the notion of competition appears never to have been tested experimentally; the notion is not currently used in the field by thymologists. Nevertheless, the animated representation of the thymus by the present invention clearly showed thymocyte traffic jams, as the cells jostle each other across chemokine gradients. Cell-competition, once noticed, is a life-or-death matter: During development, thymocytes need suitable stimulation by interacting with epithelial cells, or they die (through apoptosis termed death-by-neglect). Reactive animation shows how competition might regulate apoptosis physiologically.

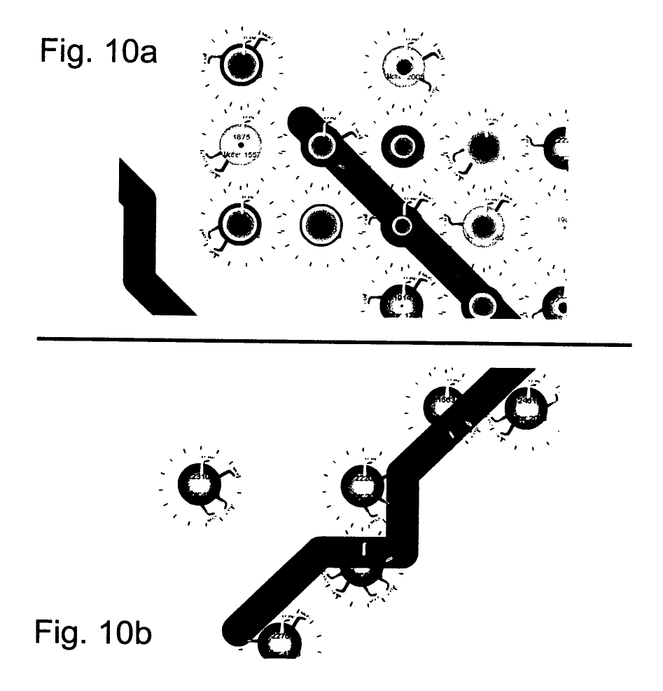

FIG. 10 shows competition between cells according to the present invention. FIG. 10A shows the vicinity of an epithelial cell when competition is intact. The cells compete to touch the face of the epithelial cell process, displayed as the blue diagonal line. FIG. 10B shows the results without competition, in which the cells easily find contact stations for interactions with the epithelial cell, and do not interfere with one another. The thymocytes are color-coded as in FIG. 9.

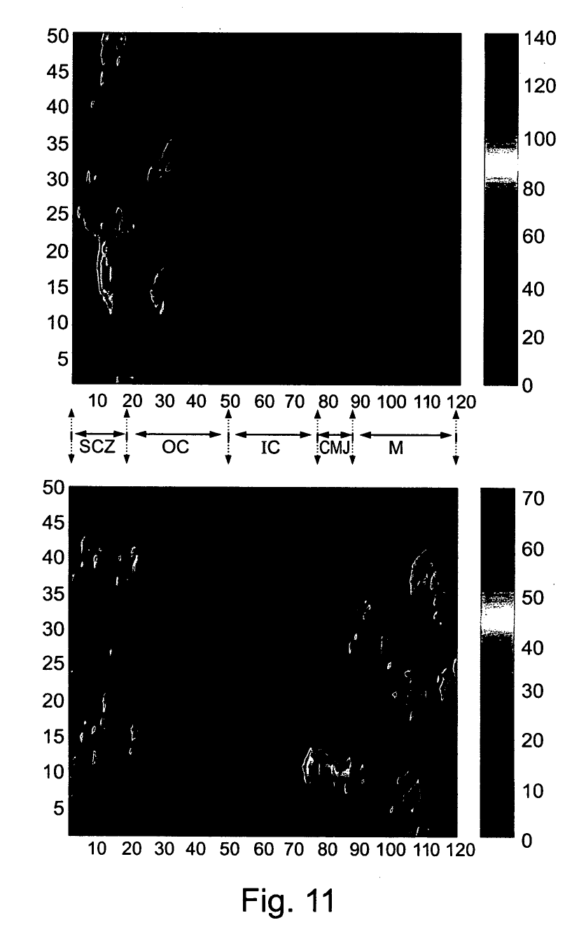

The present invention was also used to demonstrate that cell competition generates zones of apoptosis and differentiation. It was found to be possible to augment or decrease thymocyte competition by modifying kinetic constants but it was found that eliminating competition allowed too much survival, and this abolished the normal pattern of apoptosis concentrated in the sub-capsular zone and the outer cortex; moreover, thymocytes congregated in the medulla and there died for lack of survival signals (see FIG. 10 and FIG. 11).

FIG. 11 shows that competition influences the cell apoptosis profile locally. The panels show color-coded levels of apoptosis (red signifies higher amounts of apoptosis, and blue lower). FIG. 11A shows the apoptosis pattern when competition is intact. This pattern agrees with experiments performed by others, which represent knowledge in the field: most apoptosis takes place in the cortex. FIG. 11B displays the apoptosis pattern in the absence of competition. Most apoptosis is in the medulla, either through negative selection or death by neglect. This outcome is contradicted by experimental results performed by others since as noted above, most apoptosis occurs in the cortex.

Reactive animation thus makes obvious the heretofore unappreciated role of cell competition in thymocyte physiology.

The present invention was also used to examine chemokine consumption, and revealed that excessive apoptosis and abnormal differentiation will occur, unless chemokines are internalized or destroyed when they bind to chemokine receptors.

The present invention also showed that competition selects faster thymocytes: The results suggest that thymic competition could be a dress rehearsal for T-cell performance in the periphery Speed can be critical. T cells have to enter inflamed tissues quickly to protect the body from multiplying pathogens. Indeed, the simulation of the present invention shows that the faster thymocytes better survive thymic selection (data not shown). The velocity of migrating T cells would seem to have been overlooked experimentally.

The present invention also demonstrated that competition determines lineage ratio. A developing thymocyte must choose whether to become a CD4 T cell (helper) or a CD8 T cell (cytotoxic or suppressor). The decision-making process is obscure because single positive mature CD4 or CD8 T cells evolve from precursors that are double positive for both CD4 and CD8, yet CD4 cells predominate at a 2:1 ratio. Current theories of lineage commitment are controversial. Cell competition for interaction space provides a novel solution to the 2:1 CD4:CD8 paradox. If the dissociation rates of CD8 cells from epithelial cells are lower than those of CD4 cells, then the CD8 cells will interact longer at their stations (peptide-MHC I anchor) on their epithelial cell partners.

As long as a CD8 thymocyte lingers at a peptide-MHC I station, this station is unavailable for other, competing CD8 thymocytes. Without wishing to be limited by a single hypothesis, the results from the present invention indicate that CD8 thymocytes may not compete with CD4 thymocytes, because the CD4 thymocytes compete among themselves at peptide-MHC II stations on epithelial cells. The outcome of simulating different dissociation rates for thymocyte interactions with epithelial cells was examined.

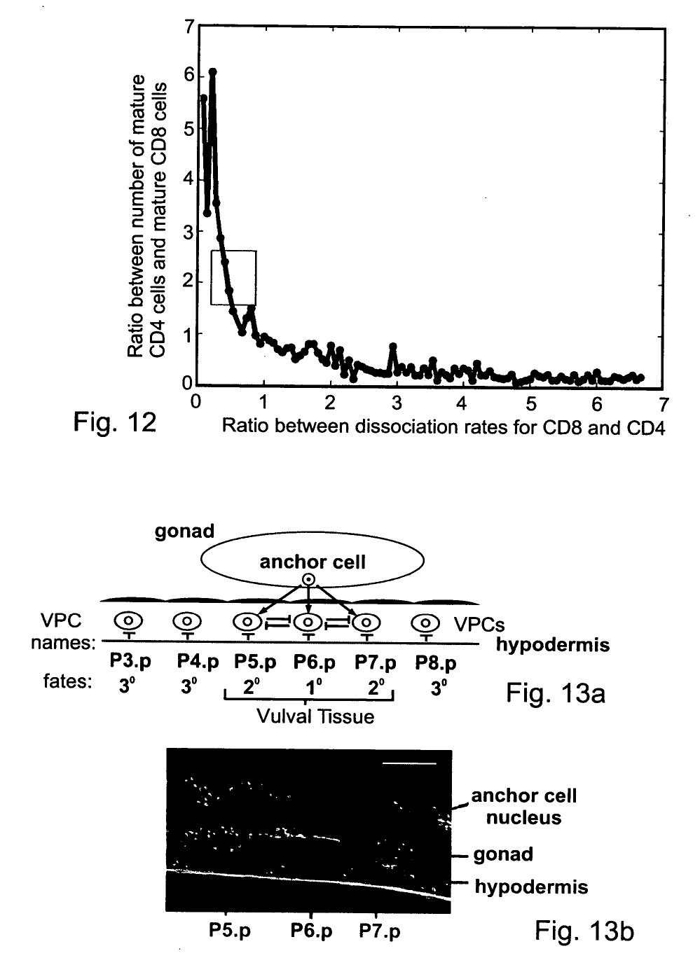

FIG. 12 shows that dissociation rates influence lineage commitment. To achieve the actual 2:1 ratio of mature. CD4 cells to mature CD8 cells, the dissociation rate of CD8 thymocytes from epithelial cells should theoretically be anywhere between 0.38 to 0.45 that of CD4 thymocytes.

As shown in FIG. 12, about two thirds of thymocytes will mature into CD4 T cells and one third into CD8 T cells (the de facto ratio) when the dissociation rate of CD8 thymocytes is 1.7 to 3.3 times slower than the dissociation rate of CD4 thymocytes. A relatively greater avidity of CD8 cells for epithelial cell stations (by 1.7-3.3) would generate the observed lineage predominance of CD4 T cells.

### EXAMPLE 3

### Modeling a Biological System—C. elegans

The nematode C. elegans has been extensively studied as a biological system. It is therefore a highly useful model organism, since it has been extensively studied and characterized at the anatomic, genetic and molecular levels. Specifically, the entire cell lineage of C. elegans has been traced, many genetic mutants have been described, and the entire genome is sequenced (Riddle, D. L., Blumenthal, T., Meyer, B. J., Priess, J. R. (eds.): C. elegans II, Cold Spring Harbor Laboratory Press Plainview, N.Y. (1997); The C. elegans Sequencing Consortium: Genome sequence of the nematode C. elegans: a platform for investigating biology. The C. elegans Sequencing Consortium, Science 282 (1998) 2012-2018).

A scenario based approach was recently used by one of the present inventors to provide formal modeling of C. elegans development, as described in “Formal Modeling of C. elegans Development: A Scenario-Based Approach”; C. Priami (Ed.): CMSB 2003, LNCS 2602, pp. 4-20, 2003; Springer-Verlag Berlin Heidelberg 2003, hereby incorporated by reference as if fully set forth herein. In this paper, two levels of data are incorporated into the model of the system. One of these levels, shared also by the models described in the Examples above, represents the ‘rules’ of the behavior of the system. These rules are based on abstractions and inferences from various sets of primary data.

The second level of data being incorporated into the model includes the “observations” that comprise the primary data itself. The set of observations utilized is a crucial component of the model, allowing both execution and verification, including consistency checks between the observations and the inferred rules. To accomplish this, preferably an inter-object, scenario-based approach to reactive system specification is used, although optionally statecharts may be used as described above.

As a specific test-case, C. elegans vulval development was modeled, although it should be emphasized that these techniques could optionally be extended for describing the entire development of the organism. The vulva is a structure through which eggs are laid. This structure derives from three cells within a set of six cells with an equivalent set of multiple developmental potentials (FIG. 13). These six cells are named P3.p, P4.p, P5.p, P6.p, P7.p and P8.p (collectively termed P(3-8).p). Due to their potential to participate in the formation of the vulva, they are also known as the vulval precursor cells (VPCs). Each has the potential to acquire either a non-vulval fate (a 3° fate) or one of two vulval cell fates (a 1° or a 2° cell fate; see FIG. 13). During normal development, after a series of cell divisions in a characteristic pattern, a vulva consisting of 22 nuclei is formed. Vulval development was one of the first areas to which considerable effort was applied to achieve a molecular understanding of how cells acquire their particular fates. This system, though limited in cell number, is quite complex and ultimately integrates at least four different molecular signaling pathways in three different interacting tissue types. Cell fate acquisition in development also occurs in the context of cell cycle control and the general global controls on the growth and development of the organism. Hence, vulval development indeed represents a rather complex reactive system.

For this non-limiting Example, an inter-object, scenario-based modeling approach was adopted, using the language of live sequence charts (LSCs) (as described in Damm, W. and Harel, D., LSCs: Breathing Life into Message Sequence Charts, Formal Methods in System Design 19:1 (2001). (Preliminary version in Proc. 3rd IFIP Int. Conf. on Formal Methods for Open Object-Based Distributed Systems (FMOODS'99), (P. Ciancarini, A. Fantechi and R. Gorrieri, eds.), Kluwer Academic Publishers, 1999, pp. 293-312.)) and the play-in/play-out methodology, both supported by the Play-Engine modeling tool (Harel, D. and Marelly, R Come, Let's Play: A Scenario-Based Approach to Programming, Springer-Verlag, (2003); Harel, D. and Marelly, R., Specifying and Executing Behavioral Requirements: The Play In/Play-Out Approach, Software and System Modeling (SoSyM), (2003)). The decision to take this approach, rather than the statechart-based one, emerged from the consideration of how to best represent the C. elegans data formally, and how to best carry out the formalization process. The previously described references describe a language (live sequence charts, or LSCs), two techniques (play-in and play-out), and a supporting tool (the Play-Engine), for capturing reactive behavior in a scenario-based fashion. Further information may be found in US Patent Published Application No. 2002-0100015, published on Jul. 25, 2002, which is owned in common with the present application and which is hereby incorporated by reference as if fully set forth herein.

LSCs constitute a visual formalism for specifying sequences of events and message passing activity between objects. They can specify scenarios of behavior that cut across object boundaries and exhibit a variety of modalities, such as scenarios that can occur, ones that must occur, ones that may not occur (called anti-scenarios), ones that must follow others, ones that overlap with others, and more. Technically, there are two types of LSCs, universal and existential. The elements of LSCs (events, messages, guarding conditions, etc.) can be either mandatory (called hot in LSC terminology) or provisional (called cold). Universal charts are the more important ones for modeling, and comprise a prechart and a main chart, the former triggering the execution of the latter. Thus, a universal LSC states that whenever the scenario in the prechart occurs (e.g., the user has flipped a switch), the scenario in the main chart must follow it (e.g., the light goes on). Thus, the relation between the prechart and the chart body can be viewed as a dynamic condition-result: if and when the former occurs, the system is obligated to satisfy the latter.

Play-in/play-out is a recently developed process for modeling in LSCs, with which one can conveniently capture inter-object scenario-based behavior, execute it, and simulate the modeled system in full. The play-in part of the method enables individuals who are unfamiliar with LSCs to specify system behavior using a high level, intuitive and user-friendly mechanism. The process asks that the user first build the graphical user interface (GUI) of the system, with no behavior built into it. The user then ‘plays’ the GUI by clicking the graphical control elements (in electronic systems these might be buttons, knobs, and so on), in an intuitive manner, in this way giving the engine sequences of events and actions, and teaching it how the system should respond to them. As this is being done, the Play-Engine preferably continuously constructs the corresponding LSCs automatically.

While play-in is the analogue of writing programs, play-out is the analogue of running them. Here the user simply plays the GUI as he/she would have done when executing the real system, also by clicking buttons and rotating knobs, and so on, but limiting him/herself to end-user and external environment actions. As this is occurring, the Play-Engine interacts with the GUI and uses it to reflect the system state at any given moment. The scenarios played in using any number of LSCs are all taken into account during play-out, so that the user gets the full effect of the system with all its modeled behaviors operating correctly in tandem. All specified ramifications entailed by an occurring event or action will immediately be carried out by the engine automatically, regardless of where in the LSCs it was originally specified. Also, any violations of constraints (e.g., paying out an anti-scenario) or contradictions between scenarios are detected if attempted. This kind of sweeping integration of the specified condition-result style behavior is useful for biological systems, where it can often be very difficult to connect the many pieces of behavioral data that are continuously discovered or refined.

This implementation of modeling was performed with regard to a two-dimensional GUI. Clearly, a far better and more informative version of the C. elegans model would be one where the front end is animated using a powerful animation tool, like Flash™ or Director™. The paper, by contrast, describes a mere GUI, static in nature with limited changing features (such as line types and colors). This model may optionally be implemented with an animation engine, such as Director™ (described above with regard to operation with the Play-Engine), according to the present invention. Such an implementation would be able to show the actual cells dividing, and the newly formed ones moving into place, gradually forming the vulval opening.

Optionally and more preferably, three-dimensional animation may be used for showing the development of the cells in C. elegans, also as described above with regard to operation of Director™ with the Play-Engine), according to the present invention.

### EXAMPLE 4

### A Computer Game System

The present invention may also optionally be used for computer games, such as for role-playing games for example. These games feature a controlled environment, featuring a plurality of actors (characters of various types) which interact with the environment. As previously described, these games have had limited functionality because all of the animation (including the interactions between characters and the environment) needed to be scripted in a fixed manner.

The present invention enables all aspects of the environment and the characters to be decomposed into a large set of objects. These objects may then interact with each other, for example as described by a state-chart; the resultant animation is then preferably produced by an animation engine of some type, as previously described. Characters may themselves optionally and preferably be decomposed into a plurality of objects, such as head, torso, arms, legs etc; these objects may themselves be further decomposed (for example, an arm may be composed of a shoulder joint, an elbow joint, a wrist joint, a hand, fingers and so forth).

The objects are then preferably animated according to their interactions with each other and the environment. For example, if a character falls, the animation preferably includes the individual (sequential or concurrent) movements of the different parts of the body as the character falls. The field of reverse kinematics may optionally be used to provide such animation of object motion, preferably in combination with secondary motion. Reverse kinematics has been used to describe the movement of robots, and is visually perceived as providing a stiff, robot-like set of movements; this problem may optionally be used through the use of secondary motion, which describes the complex set of motions apart from the primary motion that are executed when a “living” human or animal (or other character) moves (see www.cc.gatech.edu/gvu/animation/Areas/secondary/secondary.html; www.cc.gatech.edu/gvu/animation/Areas/secondary/publications.html; and www.cg.tuwien.ac.at/studentwork/CESCG/CESCG-2002/LBarinka/, as of Dec. 23, 2003, all of which are hereby incorporated by reference as if fully set forth herein).

The present invention may also optionally be used for secondary animation, which is obtained when motion detectors are used on an actor to detect the basic motions of the actor. Animation is then overlaid on top of these basic motions. The present invention could optionally be used to tweak the raw motion data for more realistic animation. For example, animation could optionally be provided as a mixture of reactive animation and regular animation.

The present invention may optionally be used in many different types of implementations and applications, examples of which include, but are not limited to, analysis of any complex and dynamic data; teaching and course design; monitoring the evolution of any system; predicting system behavior in response to intervention; for example, in biological systems, health and disease, pharmaceutical development, system design, system modification, patient monitoring, etc; decentralization of presentation and analysis: the animation may be viewed and studied at sites removed from the site at which the specifications are controlled; organizational planning; strategic and tactical planning in the military; war games, transport, communications, etc; transport and delivery system planning and analysis; any dynamic system that the human mind would understand better by animated visualization; any dynamic system that needs specification, either for design (to help build the system) or for analysis (to know how the system works, e.g. biology) and would benefit from a non-intrusive visualization.

The present invention could also optionally be used as a simulation or training tool (or a general interface) for any type of control system for controlling a large number of moving objects, particularly for a large scale system with moving objects, and dynamically created, changed and destroyed objects. For example for a military application, targets may appear and then become destroyed, missiles move, and so forth. These types of systems may be better understood through application of the present invention. Other non-limiting examples of such systems include GSP navigation systems, radar systems and traffic control systems.

The present invention may also optionally be used for handheld computers such as palm top computers, wearable computers, cellular telephones, PDAs and so forth, in conjunction with WiFi or other wireless communication technology (such as Bluetooth for example). These computers could then optionally drawn on the computing power of a larger computer and/or a plurality of computers with which the handheld computer would be in contact and which would have the reactive engine of the present invention. This system could optionally be used to run any type of software, and/or for multi-player games, for example.

According to preferred embodiments of the present invention, there is provided a system for at least providing an interface to a control system, the control system featuring a large number of dynamically created, changed and destroyed moving objects, comprising: (a) an event driven engine for modeling the objects according to a plurality of events; (b) an animation engine for creating a visual depiction at least of each of the events; wherein the event driven engine detects an event associated with the object in the control system, and wherein the animation engine creates the visual depiction according to the event for being provided to the interface. By “large scale” it is meant having a sufficiently large number of objects that manually animating and/or otherwise modeling the behavior of the objects becomes inefficient, difficult or even prohibitively complex to perform.

According to another preferred embodiment, there is provided a method for analyzing a population having a large number of interacting components, the method comprising: providing data related to a plurality of activities of the population; analyzing the data to form at least one specification; decomposing the at least one specification into a plurality of events for at least a portion of the plurality of components according to the at least one specification; and creating reactive animation of the at least a portion of the plurality of components, the reactive animation being at least partially determined according to the plurality of events. Again, “large number of interacting components” is preferably defined as having a sufficiently large number of interacting components that manually animating and/or otherwise modeling the behavior of the components becomes inefficient, difficult or even prohibitively complex to perform.

Optionally and preferably, the method includes detecting at least one property of the population through analyzing the reactive animation.

According to another preferred embodiment of the present invention for biological systems, the above embodiments may optionally be applied for biological systems having a plurality of biological components.

The present invention provides clear advantages, and clearly differs over other attempted solutions that are known in the art. For example, for some computer games, more than one action may be performed at a given point in the game. However, every single path is set even though there may be multiple paths. In other words, computer games only permit a finite number of predetermined paths.

In contrast, in the present invention, there are no preset paths. For example in a stateful system, the path taken by the reactive animation cannot be known in advance. From each state, a transition may be made to any one of a number of different states. With a relatively small number of states, the number of different possibilities becomes huge. When there are enough factors within a stateful system, there may be a combinatorial explosion and the number of paths may effectively become infinite, as the problem of analysis of the different paths becomes NP complete. The present invention overcomes this problem preferably by using a state engine, and decomposing the representation of the system to be animated into a plurality of states, thereby avoiding the necessity to calculate predetermined paths.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### REFERENCES

[1] M. Meier-Schellersheim, SIMMUNE, a tool for Simulating and Analyzing Immune System Behavior. Doctoral dissertation. DESY (1999).
[2] D. Harel, Statecharts: A Visual Formalism for Complex Systems. Sci. Comput. Programming 8, 231-274 (1987).
[3] N. Kam, I. R. Cohen, and D. Harel, The Immune System as a Reactive System: Modeling T Cell Activation with Statecharts. To appear in Bull. Math. Bio.
[4] G. Anderson and E. J. Jenkinson, Lymphostromal Interactions In Thymic Development And Function. Nature Reviews Immunology 1, 31-40 (2001).
[5] M. Egerton, R. Scollay, and K. Shortman, The Kinetics of Mature T Cell Development in the Thymus. 87, 2579 (1990).
[6] D. C. Douek, J. M. Brenchley, M. R. Betts, D. R. Ambrozak, B. J. Hill, Y. Okamoto, J. P. Casazza, J. Kuruppu, K. Kunstman, S. Wolinsky, Z. Grossman, M. Dybul, A. Oxenius, D. A. Price, M. Connors, and R. A. Koup, HIV preferentially infects HIV-specific CD4+ T cells. Nature 417, 95-8 (2002).
[7] D. C. Douek, M. R. Betts, B. J. Hill, S. J. Little, R. Lempicki, J. A. Metcalf, J. Casazza, C. Yoder, J. W. Adelsberger, R. A. Stevens, M. W. Baseler, P. Keiser, D. D. Richman, R. T. Davey, and R. A. Koup, Evidence for increased T cell turnover and decreased thymic output in HIV infection. J Immunol 167, 6663-8 (2001).
[8] I. R. Cohen, Tending Adam's Garden: Evolving the Cognitive Immune Self, Academic Press, London (2000).
[9] J. Holoshitz, A. Matitiau, and I. R. Cohen, Role of the thymus in induction and transfer of vaccination against adjuvant arthritis with a T lymphocyte line in rats. J Clin Invest 75, 472-7 (1985).
[10] R. N. Germain, T-cell development and the CD4-CD8 lineage decision. Nat Rev Immunol 2, 309-22 (2002).
[11] B. Von Gaudecker, M. D. Kendall, and M. A. Ritter Immuno-electron microscopy of the thymic epithelial microenvironment. Microsc Res Tech 38, 237-49 (1997).
[12] N. Platt, H. Suzuki, Y. Kurihara, T. Kodama, and S. Gordon, Role for the class A macrophage scavenger receptor in the phagocytosis of apoptotic thymocytes in vitro. Proc Natl Acad Sci USA 93, 12456-60 (1996).
[13] A. Zlotnik and O. Yoshie, Chemokines: a new classification system and their role in immunity. Immunity 12, 121-7 (2000).
[14] A. M. Norment and M. J. Bevan, Role of chemokines in thymocyte development. Semin Immunol 12, 445-55 (2000).
[15] K. Yasutomo, B. Lucas, and R. N. Germain, TCR signaling for initiation and completion of thymocyte positive selection has distinct requirements for ligand quality and presenting cell type. J Immunol 165, 3015-22 (2000).
[16] N. K. Nanda and E. E. Sercarz, The positively selected T cell repertoire: is it exclusively restricted to the selecting MHC? Int Immunol 7, 353-8 (1995).
[17] D. Harel, Statecharts: A Visual Formalism for Complex Systems. Sci. Comput. Programming 8, 231-274 (1987).
[18] D. Harel and M. Politi, Modeling reactive systems with statecharts: the statemate approach, McGraw-Hill, New York (1998).
[1911. Khriss, M. Elkoutby, and R. K. Keller, Automating the Synthesis of UML Statecharts Diagrams from Multiple Collaboration Diagrams. Lecture Notes in Computer Science 1618, 132-147 (1999).
[20] S. A. Seshia, R. K. Shyamasundar, A. K. Bhattacharjee, and S. D. Dhodapkar, A Translation of Statecharts to Esterel. Lecture Notes in Computer Science 1709, 983-1007 (1999).
[21] A. Maggiolo Schettini, A. Peron, and S. Tini, CONCUR '96: Concurrency Theory (Pisa). Lecture Notes in Computer Science 1119, 687-902 (1996).
[22] K. Bogdanov, M. Holcombe, and H. Singh, Automated Test Set Generation for Statecharts. Lecture Notes in Computer Science 1641, 107-121 (1999).
[23] C. Kobryn, UML 2001: A Standarization Odyssey. Communications of the ACM 42, 29-37 (1999).
[24] D. Harel and E. Gery, Executable Object Modeling with Statecharts. IEEE Computer 30, 31-42 (1997).
[25] D. B. Sant'Angelo, B. Lucas, P. G. Waterbury, B. Cohen, T. Brabb, J. Goverman, R. N. Germain, and C. A. Janeway Jr, A molecular map of T cell development. Immunity 9, 179-86 (1998).
[26] R. W. Dutton, L. M. Bradley, and S. L. Swain, T cell memory. Annu Rev Immunol 16, 201-23 (1998).
[27] E. M. Shevach, CD4+ CD25+suppressor T cells: more questions than answers. Nat Rev Immunol 2, 389-400 (2002).
[28] F. Mor, B. Reizis, I. R. Cohen, and L. Steinman, IL-2 and TNF receptors as targets of regulatory T-T interactions: isolation and characterization of cytokine receptor-reactive T cell lines in the Lewis rat. J Immunol 157, 4855-61 (1996).
[29] I. R. Cohen and H. Wekerle, Regulation of T-lymphocyte autosensitization. Transplant Proc 5, 83-5 (1973).
[30] D. Elias, Y. Tikochinski, G. Frankel, and I. R. Cohen, Regulation of NOD mouse autoimmune diabetes by T cells that recognize a TCR CDR3 peptide. Int Immunol 11, 957-66 (1999).
[31] A. Coutinho, S. Hori, T. Carvalho, I. Caramalho, and J. Demengeot, Regulatory T cells: the physiology of autoreactivity in dominant tolerance and “quality control” of immune responses. Immunol Rev 182, 89-98 (2001).
[32] M. Zaitseva, T. Kawamura, R. Loomis, H. Goldstein, A. Blauvelt, and H. Golding, Stromal-derived factor 1 expression in the human thymus. J Immunol 168, 2609-17 (2002).
[33] D. Chantry, P. Romagnani, C. J. Raport, C. L. Wood, A. Epp, S. Romagnani, and P. W. Gray, Macrophage-derived chemokine is localized to thymic medullary epithelial cells and is a chemoattractant for CD3(+), CD4(+), CD8(low) thymocytes. Blood 94, 1890-8 (1999).
[34] W. Savino, D. A. Mendes-da-Cruz, J. S. Silva, M. Dardenne, and V. Cotta-de-Almeida, Intrathymic. T-cell migration: a combinatorial interplay of extracellular matrix and chemokines? Trends Immunol 23, 305-13 (2002).
[35] L. Carmel, D. Harel, and Y. Koren, Drawing Directed Graphs Using One-Dimensional Optimization. To Appear in Graph Drawing 2002. (2002).
[36] C. Janeway et. al., Immunobiology: the immune system in health and disease, Garland Pub., New York (2001).
[37] F. Annunziato, P. Romagnani, L. Cosmi, E. Lazzeri, and S. Romagnani, Chemokines and lymphopoiesis in human thymus: Trends Immunol 22, 277-81 (2001).
[38] J. R. Taylor Jr, K. C. Kimbrell, R. Scoggins, M. Delaney, L. Wu, and D. Camerini, Expression and function of chemokine receptors on human thymocytes: implications for infection by human immunodeficiency virus type 1. J Virol 75, 8752-60 (2001).
[39] C. H. Kim, L. M. Pelus, J. R. White, and H. E. Broxmeyer, Differential chemotactic behavior of developing T cells in response to thymic chemokines. Blood 91, 4434-43 (1998).
[40] J. J. Campbell, J. Pan, and E. C. Butcher, Cutting edge: developmental switches in chemokine responses during T cell maturation. J Immunol 163, 2353-7 (1999).
[41] M. R. Tourigny, S. Mazel, D. B. Burtrum, and H. T. Petrie, T cell receptor (TCR)-beta gene recombination: dissociation from cell cycle regulation and developmental progression during T cell ontogeny. J Exp Med 185, 1549-56 (1997).
[42] E. F. Lind, S. E. Prockop, H. E. Porritt, and H. T. Petrie, Mapping precursor movement through the postnatal thymus reveals specific microenvironments supporting defined stages of early lymphoid development. J Exp Med 194, 127-34 (2001).
[43] C. Penit, B. Lucas, and F. Vasseur, Cell expansion and growth arrest phases during the transition from precursor (CD4−8−) to immature (CD4+8+) thymocytes in normal and genetically modified mice. J Immunol 154, 5103-13 (1995).
44] C. C. Bleul and T. Boehm, Chemokines define distinct microenvironments in the developing thymus. Eur J Immunol 30, 3371-9 (2000).
[45] B. S. Youn, C. H. Kim, F. O. Smith, and H. E. Broxmeyer, TECK, an efficacious chemoattractant for human thymocytes, uses GPR-9-6/CCR9 as a specific receptor. Blood 94, 2533-6 (1999).
[46] C. Hernandez-Lopez, A. Varas, R Sacedon, E. Jimenez, J. J. Munoz, A. G. Zapata, and A. Vicente, Stromal cell-derived factor 1/CXCR4 signaling is critical for early human T-cell development. Blood 99, 546-54 (2002).
[47] M. A. Ritter and Crispe I. N., The Thymus, Oxford University Press, New York (1992).
[48] M. Tomita, Whole-cell simulation: a grand challenge of the 21st century. Trends Biotechnol 19, 205-10 (2001).
[49] Bartol T. M. and Stiles J. R., MCell. http://www.mcell.cnl.salk.edu/. 2002.
[50] R. Cohen, Talmudic Texts for Visiting Scientists: On the Ideology and Hermeneutics of Science. In preparation.

1. A method for producing animation of an object comprising:
modeling a behavior of the object as a plurality of events;
creating a visual depiction at least of said plurality of events;
detecting an event associated with the object; and
creating the animation according to said event with said visual depiction.

2. The method according to claim 1, wherein said plurality of events comprises a plurality of temporal samples or a plurality of scenarios.

3. The method according to claim 1, wherein said plurality of events comprises a plurality of states.

4. The method according to claim 3, further comprising:
determining at least one transition between said plurality of states.

5. The method of claim 4, wherein said at least one transition is determined according to at least one rule.

6. The method of claim 3, wherein said creating said visual depiction further comprises creating a visual depiction of said at least one transition.

7. The method of claim 3, wherein said state represents an interaction between a plurality of objects.

8. The method of claim 3, further comprising:
interacting between a plurality of objects; and
altering a state of at least one object according to said interacting.

9. The method of claim 3, further comprising:
receiving an external input; and
altering a state of at least one object according to said external input.

10. The method of claim 9, wherein said external input is provided through a user interface.

11. The method of claim 10, wherein said user interface is for interacting with a computer game.

12. The method of claim 3, wherein said detecting said state is performed by a state engine, and wherein said creating the animation is performed by an animation engine, the method further comprising:
receiving a command from said state engine;
parsing said command to determining said state of said object; and
translating said command to a format for said animation engine for creating the animation.

13. A system for producing reactive animation of an object, wherein a behavior of the object is modeled as a plurality of events, comprising:
(a) an event driven engine for modeling the plurality of states and at least one transition between the plurality of events;
(b) an animation engine for creating a visual depiction at least of each of the plurality of events; and
(c) an interface for receiving an event associated with the object from the event driven engine, and for sending a command to said animation engine for creating said visual depiction according to said event.

14. The system according to claim 13, wherein:
said event driven engine comprises a temporal logic engine or a scenario based engine; and
said plurality of events comprises a plurality of time samples or a plurality of scenarios.

15. The system according to claim 13, wherein:
said event driven engine comprises a state engine; and
said plurality of events comprises a plurality of states.

16. The system according to claim 15, further comprising:
a plurality of statecharts; and
a state processor.

17. The system according to claim 13, wherein the animation engine comprises:
a plurality of animation pieces;
a rendering engine; and
an input translator.

18. The system of claim 14, wherein said state engine comprises Rhapsody™ and said animation engine comprises Flash™.

19. The system according to claim 13, further comprising:
(d) an external input module for sending a command to said interface for interacting with the object.

20. The system of claim 19, wherein said external input module comprises a user interface.

21. The system of claim 20, wherein the user interface operates in response to mouse clicks.

22. The system of claim 20, wherein the user interface is comprised within the animation engine.

23. The system of claim 20 wherein the user interface is operatively associated with the animation engine.

24. The system of claim 20 wherein the user interface is comprised within the interface.

25. The system of claim 20 wherein the user interface is operatively associated with the interface.

26. A method for analyzing a biological system, the biological system featuring a plurality of biological components, the method comprising:
providing data related to a plurality of activities of the plurality of biological components of the biological system;
analyzing the data to form at least one specification;
constructing a plurality of states and at least one transition for at least a portion of the plurality of biological components according to said at least one specification; and
creating a visual depiction of said at least a portion of the plurality of biological components in each of said plurality of states.

27. The method of claim 26, further comprising:
detecting a state of at least one biological component; and
creating animation according to said state with said visual depiction.

28. The method of claim 27, wherein the biological system comprises a thymus.

29. A method for analyzing a biological system, the biological system featuring a plurality of biological components, the method comprising:
providing data related to a plurality of activities of the plurality of biological components of the biological system;
analyzing the data to form at least one specification;
decomposing said at least one specification into a plurality of events for at least a portion of the plurality of biological components according to said at least one specification; and
creating reactive animation of said at least a portion of the plurality of biological components, said reactive animation being at least partially determined according to said plurality of events.

30. The method of claim 29, further comprising:
detecting at least one property of the biological system through analyzing said reactive animation.

31. A method for analyzing a population having a large number of interacting components, the method comprising:
providing data related to a plurality of activities of the population;
analyzing the data to form at least one specification;
decomposing said at least one specification into a plurality of events for at least a portion of the plurality of components according to said at least one specification; and
creating reactive animation of said at least a portion of the plurality of components, said reactive animation being at least partially determined according to said plurality of events.

32. The method of claim 31, further comprising:
detecting at least one property of the population through analyzing said reactive animation.

33. A system for at least providing an interface to a control system, the control system featuring a large number of dynamically created, changed and destroyed moving objects, comprising:
(a) an event driven engine for modeling the objects according to a plurality of events;
(b) an animation engine for creating a visual depiction at least of each of the events;
wherein said event driven engine detects an event associated with the object in the control system, and wherein said animation engine creates said visual depiction according to said event for being provided to the interface.
